(19) United States
(12) Patent Application Publication
(10) Pub. No.: US 2023/0100027 A1
(43) Pub. Date: Mar. 30, 2023

(54) CRYSTALLIZABLE LITHIUM ALUMINUM SILICATE GLASS AND GLASS CERAMIC PRODUCED THEREFROM

(71) Applicant: SCHOTT AG, Mainz (DE)

(72) Inventors: Hüseyin Özcoban, Mainz (DE); Evelin Weiss, Mainz (DE); Susanne Krüger, Mainz (DE); Uwe Martens, Mainz-Kastel (DE); Friedrich Siebers, Nierstein (DE); Thoralf Johansson, Nieder-Olm (DE)

(73) Assignee: SCHOTT AG, Mainz (DE)

(21) Appl. No.: 17/895,166

(22) Filed: Aug. 25, 2022

(30) Foreign Application Priority Data
Aug. 25, 2021 (DE) 10 2021 122 035.1

(51) Int. Cl. C03C 10/00; C03C 4/02; C03B 32/02

(52) U.S. Cl. CPC C03C 10/0027; C03C 10/0009; C03C 10/0054; C03C 4/02; C03B 32/02; C03C 2204/04

(57) ABSTRACT

A lithium aluminum silicate glass ceramic, which, apart from unavoidable impurities, is As2O3-free and Sb2O3-free. The lithium aluminum silicate glass ceramic has keatite as primary crystal phase and a keatite peak temperature TP of the keatite solid solution formation in the range of 980° C. to 1090° C., and the keatite peak temperature TP is determined by dynamic differential calorimetry (DSC) in accordance with DIN 51007:2019-04 at a heating rate of 5 K/min. A ceramization method is also described.

### CROSS REFERENCE TO RELATED APPLICATION

This application claims the benefit under 35 U.S.C. § 119(a) of German Application No. 10 2021 122 035.1 filed Aug. 25, 2021, the contents of which are incorporated by reference herein in their entirety.

### BACKGROUND OF THE DISCLOSURE

### 1. Field of the Disclosure

The invention relates to a lithium aluminum silicate glass ceramic (LAS glass ceramic) and to a ceramization method for the production thereof and the use of such a LAS glass ceramic.

### 2. Description of the Related Art

LAS glass ceramics have found broad use on account of their special material properties, such as, for example, their low coefficients of thermal expansion in association with a high resistance to temperature differences and a high thermoshock resistance, their high strength, their chemical resistance, and their transparency. As a rule, the thermal expansion behavior is adjusted in such a way that, in the range of their application temperatures, the materials have very low coefficients of mean linear thermal expansion, generally −2.0×10⁻⁶/K≤α̅(20° C.; 700° C.)≤2.0×10⁻⁶/K. Requirements for the use at high temperatures entail that the glass ceramics retain the required properties (such as, for example, thermal expansion, transmission, thermal stability) during their service life. In regard to thermal stability, the critical parameter is the shrinkage of the glass ceramic (compaction) at high temperatures, even when it is small. Because the glass ceramic article generally warms up nonuniformly during use, stresses build up in the article otherwise with time owing to locally differing strong shrinkage.

Widespread applications of the LAS glass ceramics are fire-protection glazings, cookware, transparent fireplace viewing panels, and oven viewing windows as well as cooktops. In applications as cooktops, the transparent glass ceramic plates are either colored with oxide colorants or else furnished with a visually thick, generally colored coating on the bottom, so as to prevent the technical fixtures from being viewed and to provide the colored look. Recesses in the underside coating enable colored or white display indicators, generally light-emitting diodes or display screens, to be applied.

Transmission and scattering are important properties for the appearance and the optical properties of glass ceramics.

High transparency means high brightness and a low degree of color. Both mean low absorption, because the absorption bands, depending on their position in the visual spectrum, both lower the brightness and increase the degree of color. In the literature, the terms light transmission or integral transmission are also found for the term brightness.

The scattering is determined by the size of the crystals, the birefringence thereof, and the difference in the refractive indices between the crystals and the remaining glass. As a rule, a low scattering is desired in order that the transparency is not falsified and the indicators are clearly and markedly visible.

The brightness or light transmission is described by the brightness value Y (brightness) in accordance with the CIE color space system or the perceptual lightness L* in the CIELAB color space system. The definition of the color space system to be used is established in the German implementation of the international CIE standard, namely, DIN 5033. The evaluation of the measurement data in accordance with the CIELAB color space model is described in DIN EN ISO 11664-4 “Colorimetry—Part 4: CIE 1976 L*a*b* Colour space” and, namely, is done so both for measurements in transmission and for measurements in reflection.

In the scope of the invention, the spectrophotometric measurements required for this occur on polished specimens in a spectral range between 380 nm and 780 nm. From the measured spectral values in the range that represents the visible light spectrum, both the brightness Y and the perceptual lightness L* and the color coordinates a* and b* are calculated with choice of standard illuminant and observation angle for the thickness present. The determination of the brightness Y is made from the spectral values of a transmission measurement that was carried out in accordance with DIN ISO 15368. In addition, the transmission was determined at defined wavelengths.

For glass ceramics, it has become customary to specify the parameters L*, a*, b* as a measure for the color impression of translucent and opaque variants. The determination of these values is made from the spectral values of a reflection measurement, which is carried out in accordance with DIN ISO 15368. L* describes here the brightness (perceptual lightness) and the coordinates a* and b* each describe the color shift, whereby

+a*=specifies a shift towards red
−a*=specifies a shift towards green
+b*=specifies a shift towards yellow
−b*=specifies a shift towards blue

Determined from a* and b* is the value c*, which is referred to as chroma, and, namely, is done so according to the following equation:

c*=\sqrt{(a*)²+(b*)²}. Formula

The large-scale industrial production of glass ceramics occurs in a number of stages. First of all, the crystallizable starting glass, consisting of a mixture of shards and a powdered raw material batch is melted and refined. The glass melt thereby reaches temperatures of 1550° C. up to at most 1750° C., generally up to 1700° C. In certain cases, a high-temperature refining above 1750° C., usually at temperatures of around 1900° C., is employed. For non-colored glass ceramics, arsenic and antimony oxide are technically and economically proven refining agents at conventional refining temperatures below 1700° C. in regard to good bubble qualities. Arsenic oxide is especially advantageous for the transparency (high brightness and low degree of color) of the glass ceramic. Even when these refining agents are permanently incorporated in the glass scaffold, they are disadvantageous in terms of the aspects of safety and environmental protection. Accordingly, special precautions have to be taken during the recovery and processing of raw materials and because of vaporization from the melt during glass production. For this reason, there have been numerous developmental efforts to replace these substances, although these efforts have met with technical and economic drawbacks.

After melting and refinement, the glass usually undergoes a hot-forming by casting, pressing, rolling, or floating. For many applications, the glass ceramics are required to be in flat form, such as, for example, in the form of panels. Rolling and floating are employed for producing the panels. Desired for the economical production of these LAS glasses are a low melting temperature and a low processing temperature VA during the hot-forming. Furthermore, during the forming, the glass should not exhibit any devitrification; that is, crystals that are larger than about 5 μm, which lower the strength in glass ceramic articles or are visually disturbing, should not form. Because the forming takes place in the vicinity of the processing temperature VA (viscosity 10⁴ dPa·s) of the glass, it needs to be ensured that the upper devitrification temperature of the melt lies in the vicinity of and preferably below the processing temperature in order to prevent the formation of larger crystals. The critical region during the forming by way of rollers is the contact of the glass melt with the drawing nozzle made of precious metal (usually made from a Pt/Rh alloy), before the glass is shaped by the rolling and cooled. During floating, the critical region is the glass contact with the spout lip and the front region of the float bath in contact with the molten tin, in which the glass has a high crystal growth rate.

The crystallizable LAS glass is transformed to the glass ceramic in a subsequent heating process by controlled crystallization (ceramization). This ceramization occurs in a multistage heating process, in which, first of all, seeds, usually consisting of ZrO2/TiO2 solid solutions, are produced by nucleation at a temperature between 680° C. and 800° C. SnO2 is also involved in the nucleation. As the temperature is increased further, high-quartz solid solutions (HQ solid solutions) are formed and are transformed into keatite solid solutions as the temperature is continuously further increased in a temperature range of 900° C. to 1250° C. The temperature-time conditions for the transformation here depend on the composition and, to a lesser degree, on the thermal pretreatment. The transformation to keatite solid solutions is associated with larger crystals, which result in an increasing scattering of light. The transformation also results in an increase in the coefficient of mean linear thermal expansion α̅(20° C.; 700° C.) of the glass ceramic. The light transmission is reduced and the glass ceramic appears translucent. With a further increase in the temperature, the glass ceramic becomes nearly nontransparent to light (opaque).

Longer residence times at high temperatures of the keatite formation increase the opacity of the material. The microstructure of the glass ceramic is thereby altered, so that the optical, physical, and chemical properties are changed. For an economical production, short ceramization times are advantageous.

Increasingly promoted as a replacement for arsenic and antimony oxide is the environmentally compatible refining agent SnO2, either alone or in combination with one refining additive or with a plurality of refining additives, such as halides (F, Cl, Br), CeO2, MnO2, Fe2O3, and/or sulfur compounds.

However, the use of SnO2 entails drawbacks. SnO2 itself as a refining agent is technically less effective and necessitates higher temperatures for the delivery of refinement-active oxygen. High concentrations of SnO2 on the order of magnitude of the utilized As2O3 of approximately 1 wt % are detrimental in the hot-forming because of the devitrification of Sn-containing crystals. The second key drawback for non-colored glass ceramics in regard to the substitution of tin oxide for arsenic oxide as a refining agent lies in the fact that SnO2 leads to an additional absorption and increases the color value b*. The absorption is primarily due to color complexes with the nucleating agent TiO2. At higher refining temperatures, the absorption is enhanced, because it increases with the higher proportion of Sn²⁺. The Sn/Ti color complexes color more intensely than the known Fe/Ti color complexes and this drawback has thus far impeded the substitution of tin oxide for the refining agent arsenic oxide in the case of non-colored glass ceramics.

The formation of the mentioned charge-transfer color complexes takes place predominantly during the crystallization. In order to lower the concentrations of the color complexes, it is advantageous to shorten the nucleation and crystallization times. However, this approach is opposed by the fact that the shortening of the nucleation time leads to enhanced light scattering and the shortening of the crystallization time leads to unevenness of the article.

Present in the technical batch raw materials for the melts are further coloring elements, such as Cr, Mn, Ni, V, and especially Fe as impurities. Besides the Fe/Ti color complexes, the Fe also colors ionically as Fe²⁺ or Fe³⁺. Because of the high costs of low-iron raw materials, however, it is not economical to lower the Fe2O3 content to values below approximately 50 ppm.

The approaches of preventing (WO 2008/065167 A1) or limiting (WO 2008/065166 A1) the nucleating agent TiO2 that is co-responsible for the color complexes in transparent non-colored glass ceramics that contain, as primary crystal phase, high-quartz solid solutions, which, in the literature, are also referred to as “β-quartz” or “β-eucryptite,” have hitherto not led to a technical implementation. The required higher contents of the alternative nucleating agents ZrO2 and/or SnO2 lead to drawbacks in melting and forming, such as higher melting and forming temperatures, as well as to inadequate devitrification resistance during the forming.

Also, in the case of translucent to opaque non-colored glass ceramics that contain, as primary crystal phase, keatite solid solutions, which are also referred to in the literature as “β-spodumene,” a higher TiO2 content has a negative effect on the optical properties of the glass ceramic.

Thus, WO 2019/016338 A1 describes white, opalescent or opaque, tin-refined glass ceramics of the LAS type, which contain β-spodumene as primary crystal phase with a TiO2 content limited to 1.75 wt %. The low content of TiO2 is explained there as being responsible for a positive effect on the perceptual lightness L*. However, the TiO2 content may not drop below a lower limit of 1.3 wt %, because, in this case, the crystals would become too large, as a result of which the strength and also the homogeneous appearance of the glass ceramic would be impaired. The ceramization cycle described therein provides for the following steps: rapid temperature increase from 20° C. to 670° C. at a heating rate of 25° C./min; temperature increase from 670° C. to the nucleating temperature Tn at a heating rate of 5° C./min; residence time at Tn; temperature increase from Tn to the crystal growth temperature Tc at a heating rate of 7° C./min; residence time at Tc; rapid cooling to 20° C. at a cooling rate of 25° C./min. As a rule, these known glass ceramics exhibit a high SnO2 content, which, in the production of opaque glass ceramics with a high perceptual lightness, requires high temperatures, which, in turn, increase the production costs. A further drawback lies in the fact that, when the known method is used, flat panels cannot be produced, because the heating rate for reaching Tc is very high.

WO 2019/117122 A1 describes a LAS-based glass ceramic that contains a solid β-spodumene solution as primary crystal phase. A drawback in the case of the glass ceramics disclosed here is the high coefficient of mean linear thermal expansion α̅(30° C.; 750° C.) of 11×10⁻⁷/K and greater.

In the development of glass ceramics, therefore, there is a need to accommodate an entire bundle of opposing demands placed on the glass and the glass ceramic, such as favorable manufacturing properties without any drawbacks in the product quality of the glass ceramic, such as, in particular, the degree of color, the brightness Y, and the coefficient of mean linear thermal expansion α̅(20° C.; 700° C.), for short ceramization times.

### SUMMARY

The object of the invention is to provide As2O3-free and Sb2O3-free LAS glass ceramics that have an improved perceptual lightness L* (also referred to as brightness in reflection, in contrast to the brightness Y, which is measured in transmission) and a low coefficient of mean linear thermal expansion α̅(20° C.; 700° C.) as well as to make possible the economical production thereof.

This object is achieved by way of a lithium aluminum silicate glass ceramic as described herein.

The LAS glass ceramic is produced from a starting glass or green glass by means of a ceramization method, wherein the transformation of the green glass to the keatite phase occurs at temperatures of up to 1250° C.

The formation of the keatite phase can be detected by means of dynamic differential calorimetry (DSC, in particular by use of hf-DSC) in accordance with DIN 51007:2019-04 at a heating rate of 5 K·min⁻¹. Specified here as peak temperature of the formation of keatite solid solution (also referred to as the keatite peak temperature TP) is the temperature at which the maximum for the heat of transformation is registered.

It has been found that a glass ceramic with a keatite peak temperature TP in the range of 980° C. to 1090° C. has a good color neutrality, in particular a high perceptual lightness L* and a low coefficient of mean linear thermal expansion α̅(20° C.; 700° C.).

In the claimed range of the keatite peak temperature TP, it is possible to optimize the desired properties of the glass ceramic in a simple way.

The claimed range of the keatite peak temperature TP opens up the possibility of producing the glass ceramic in a broad spectrum from opaque to translucent, whereby, in the case of the translucent glass ceramic, it is possible to differentiate between a glass ceramic that has a display capability and a glass ceramic that does not have a display capability.

Preferably, the keatite peak temperature TP lies in the range of 980° C. to 1070° C., in particular in the range of 990° C. to 1055° C. Glass ceramics with keatite peak temperatures in this temperature range can be converted economically from green glass into a glass ceramic by means of a suitable ceramization method at moderate ceramization temperatures and ceramization times.

The LAS glass ceramic comprises preferably the following components with the following proportions (in wt % based on oxide):

| | |
|---|---|
| Li2O | 3-5 |
| Al2O3 | 18-25 |
| SiO2 | 60-70 |
| SnO2 | 0-0.5, preferably |
| | 0.01-0.5, more |
| | preferably 0.05-<0.3. |

### Li2O, Al2O3, and SiO2

The oxides Li2O, Al2O3, and SiO2 are necessary components of the keatite solid solution phases. They are present preferably within the limits specified below.

For the crystallizable glass and the glass ceramic produced from it, the content of Li2O is 3 to 5 wt %. The minimum content is appropriate in order to achieve the desired low processing temperature of the glass. Preferably, the Li2O content is less than 4.5 wt %, more preferably less than 4.4 wt %, and especially preferred less than 4.3 wt %. The minimum content is preferably 3.2 wt % and especially preferred 3.4 wt %.

It has been found further that the Li2O proportion influences the keatite peak temperature TP. The higher the Li2O proportion, the lower is the keatite peak temperature TP,

Preferably, the glass ceramic contains 3.9 to 4.5 wt % Li2O, preferably up to 4.2 wt %. The keatite peak temperature TP lies preferably in the range of 990° C. to 1025° C.

Preferably, the glass ceramic contains 3.5 to <3.9 wt % Li2O. The keatite peak temperature TP lies preferably in the range of 1015° C. to 1060° C.

Lower Li2O contents have the advantage that resources and raw material costs for the production of such a glass ceramic are saved and, on account of the lower tendency towards devitrification, the production process of the green glass proceeds more robustly and, accordingly, higher yields are possible.

Higher Li2O contents have the advantage that, both in the production of the green glass and in the ceramization of the green glass to produce glass ceramic, lower temperatures can be employed.

The content of Al2O3 is preferably 18 to 25 wt %. Contents higher than 25 wt % are disadvantageous because of the tendency of mullite to undergo devitrification during forming.

The content of the main component SiO2 should preferably be at least 60 wt %, because this is advantageous for the required properties of the glass ceramic, such as, for example, a low thermal expansion and chemical resistance. Especially advantageous is a minimum content of 64 wt %. The SiO2 content should preferably be at most 70 wt %, because this component increases the processing temperature of the glass and the melting temperature. Preferably, the SiO2 content is at most 68 wt %.

### SnO2

Preferably, the glass ceramic contains 0 to 0.5 wt % SnO2.

In certain embodiment variants, it is possible to entirely dispense with SnO2. The glass ceramic preferably contains 0 wt % SnO2 when the glass is subjected to a high-temperature refinement. In a high-temperature refinement, the temperature of the glass melt is preferentially greater than 1750° C., preferably greater than 1850° C.

In accordance with a further embodiment, the glass ceramic contains SnO2. The glass ceramic therefore contains >0 wt % SnO2, preferably at least 0.01 wt % SnO2, more preferably at least 0.05 wt % SnO2 and/or at most 0.5 wt % SnO2, preferably less than 0.3 wt % SnO2.

Even at low contents, SnO2 acts as a refining agent and, in combination with technical measures on the melting tank, ensures the required bubble quality. It is the environmentally compatible alternative to the heavy metals As2O3 and Sb2O3. Furthermore, SnO2 also acts as a nucleating agent and can assist in controlling the transformation process in a significant manner. Preferably, the glass and the glass ceramic produced from it contain at least 0.03 wt % and especially preferred at least 0.04 wt % SnO2.

Preferably, the glass ceramic has a perceptual lightness L* in the color space L*, a*, b* of 60 to 97—determined from the spectral values of a reflection measurement—and a brightness Y— determined from the spectral values of a transmission measurement—of 0.1% to 25%, where L* and Y are determined using the standard illuminant D65 at an angle of 2° for a thickness of the glass ceramic of 4 mm.

The following material types can essentially be differentiated:

### Variant A

Variant A relates to an opaque LAS glass ceramic with a high perceptual lightness and a low brightness Y.

Preferably, the glass ceramic is opaque and has a keatite peak temperature TP in the range of 980° C. to 1070° C., in particular in the range of 990° C. to 1055° C., as well as the following values:

L*=85 to 97, preferably 90 to 97, especially preferred 90 to 96
a*=−1.5 to 0.5, preferably −1.2 to 0.5
b*=−6 to 0.5, preferably −4.5 to 0
and Y=0.1% to 2%, preferably 0.2% to 2%.

### Variant B

Variant B relates to a translucent LAS glass ceramic with a low perceptual lightness and a higher brightness Y.

A sharp-contour view of 7-segment displays is not possible, although the displays of residual heat or other signals is possible.

Preferably, the glass ceramic is translucent and has a keatite peak temperature TP in the range of 980° C. to 1070° C., in particular in the range of 990° C. to 1055° C., as well as the following values:

L*=72 to 93. preferably 80 to 93
a*=−5.5 to 0, preferably −5 to 0
b*=−7 to 0.5, preferably −6.5 to 0, especially preferred −6 to 0

### and Y=>2% to 10%.

### Variant C

Variant C relates to a LAS glass ceramic with a low perceptual lightness and a higher brightness Y, so that a sharp-contour visibility of red displays is possible.

Preferably, the glass ceramic is translucent and has a keatite peak temperature TP in the range of 980° C. to 1070° C., in particular in the range of 990° C. to 1055° C., as well as the following values:

L*=60 to 82, preferably 65 to 82, especially preferred 68 to 81
a*=−7.5 to −2, preferably −6.5 to −2, especially preferred −5.5 to −2
b*=−19 to −4.5, preferably −14 to −4.5, especially preferred −13.5 to −4.5
and Y=>10% to 25%, preferably >10% to 20%.

Whereas the display capability in the variants A and B is not given or not adequately indicated, it is of interest for the variant C.

The display capability is preferably evaluated by visual inspection of a glass ceramic panel with a thickness of approximately 4 mm, which is arranged on a 7-LED-segment display.

It is also possible to support the evaluation of the display capability by carrying out preferably transmission measurements based on ISO 15368.

In the measurement variant PvK (specimen in front of the sphere), the specimen is positioned in front of an integrating sphere, in which a detector is situated. This detector detects diffusely scattered light in the forward direction of the specimen at an angle of up to 10°. In the measurement variant PiP (specimen in the specimen chamber), the specimen is situated at a distance of 43 cm in front of the integrating sphere. The light that is diffusely scattered by the specimen is thereby not detected by the detector.

For the evaluation of the display capability for red displays, preferably the quotient (PvK−PiP)/PiP for light of wavelength 630 nm is employed.

For the material group “translucent” with Y values of >2%, it is possible to make the following classification of the display capability:

“Not display capable” means: No display can be seen, regardless of the angle at which the observer observes. The reproduction of the 7-LED-segment display is blurry.

An indication as to when this perception occurs is given by the quotient (PvK−PiP)/PiP. It lies at a value of >20.

“Weakly display capable” means: The sharpest reproduction of the 7-LED-segment display is seen when the view of the observer is at an angle of 90° to the display, that is, perpendicular to the display. When there is an angle deviating from 90° between the eye and the display, the display appears blurry, but still can be seen. The quotient (PvK−PiP)/PiP that affords an indication for this perception is at most 20 and preferably the quotient is at least 4.

“Well display capable” means: The display can be well seen from all angles of view and is sharp in contour, but the red region of the 7-LED-segment display appears less brilliant. The quotient (PvK−PiP)/PiP that affords an indication for this perception is at most 5.5 and preferably the quotient is at least 2.

“Very well display capable” means: Here, too, the display can be well seen from all angles of view and is sharp in contour, but the red region of the 7-LED-segment display appears less brilliant, so that the reading it is even easier. The quotient (PvK−PiP)/PiP that affords an indication for this perception is at most 3 and preferably the quotient is at least 0.

Preferably, the glass ceramic has a quotient (PvK−PiP)/PiP for light of wavelength 630 nm that is ≤20.

The presentation of the display capability in Tables 3 and 4 is based on the aforementioned classification. The numerical values of the parameters PvK and PiP as well as those of the quotients are rounded in the tables.

All three embodiments of the glass ceramic could be optimized, because the keatite peak temperature TP lies in the range of 980° C. to 1090° C. The three embodiments have the advantage that the glass ceramics have a high perceptual lightness L* as well as relatively low color values a* and b*, which influence the color neutrality in a positive manner.

The white appearance (translucent to opaque) is produced by carrying out the crystallization in a controlled manner. In special applied cases, a controlled scattering is also desired in order to produce a translucent white appearance.

Preferably, the glass ceramic has a coefficient of mean linear thermal expansion a (20° C.; 700° C.) of 0 to 2.0×10⁻⁶/K, preferably of greater than 0.5×10⁻⁶/K, and especially preferred of greater than 0.6×10⁻⁶/K. Preferably, the glass ceramic has a coefficient of mean linear thermal expansion a (20° C.; 700° C.) up to 1.5×10⁻⁶/K, preferably up to 1.4×10⁻⁶/K, and most especially preferred up to 1.0×10⁶/K.

It has been found that this property could also be improved. This embodiment has the advantage that the glass ceramic can be exposed to markedly greater temperature-change loads than is the case for the glass ceramics in accordance with prior art.

### MgO

Preferably, the glass ceramic contains 0.01 to <1 wt % MgO.

The MgO content should be less than 1 wt %, preferably at most 0.5 wt %, especially preferred at most 0.4 wt %, and most especially preferred at most 0.35 wt %. In a preferred MgO value range of 0.1 wt % to 0.4 wt %, it is possible to combine together the requirements of a low color of the glass ceramic and a lower processing temperature in an especially good manner.

In accordance with a further embodiment, the glass ceramic contains no MgO apart from impurities. This MgO-free embodiment has the advantage that an improvement of the color value c* by, for example, −3.5 to −5.5, is achieved for a comparable perceptual lightness L* with a deviation of, for example, ±1.

### ZnO

Preferably, the glass ceramic contains 0.5 to 3 wt % ZnO.

The component ZnO is advantageous for lowering the melting and processing temperature of the glass. Comparable to the component Li2O, this component leads to a reduction in the thermal expansion of the glass ceramic. Because of the tendency for vaporization to occur from the glass melt, the ZnO content is limited preferably to values of at most 3 wt %. Preferred is a ZnO content of at most 2.7 wt % and especially preferred of at most 2.5 wt %. Preferred is a minimum content of 0.5 wt % and especially preferred of greater than 1 wt %. In an especially preferred manner, the ZnO content should be 0.5 wt % to <3 wt %

Preferably, the following relation holds for the quotient of Al2O3 and Li2O+MgO+ZnO (all oxides given in wt %):

3≤Al2O3/(Li2O+MgO+ZnO)<3.2 (condition B1a),

where the glass ceramic has a keatite peak temperature TP in the range of 990° C. to 1005° C.

Preferably, the following relation holds for the quotient of Al2O3 and Li2O+MgO+ZnO (all oxides given in wt %):

3.2Al2O3/(Li2O+MgO+ZnO)<3.8 (condition B1b),

where the glass ceramic has a keatite peak temperature TP in the range of >1005° C. to 1060° C.

The observance of the condition B1a has the advantage that the transformation to a glass ceramic with keatite as primary crystal phase can occur at temperatures and/or times that are economical and energy-efficient.

The observance of the condition B1b has the advantage that, for the adjustment of the desired optical properties, the temperature range and/or the ceramization time can be chosen more broadly and the intended properties of the glass ceramic can be better controlled.

The conditions B1a and B1b preferably also hold for MgO-free compositions of the glass ceramic.

### Alkalis Na2O and K2O

Preferably, the glass ceramic contains (in wt % based on oxide):

### Na2O 0-1 and

### K2O 0-1

with the condition B2a

0.1≤Na2O+K2O≤1.5.

Preferably, the glass ceramic contains (in wt % based on oxide):

### Na2O 0-1 and

### K2O>0−1

with the condition B2b

0.05≤Na2O/K2O≤1.2.

Preferably, for the condition B2b, a range of 0.05 to 0.7, in particular of 0.1 to 0.65, applies.

The alkalis Na2O and K2O lower the melting temperature and the processing temperature during the forming of the glass. The melting of sparingly soluble raw materials, such as ZrO2 and SiO2, is accelerated. The contents in the case of both alkalis Na2O and K2O have to be limited to at most 1 wt %, because these components are not incorporated in the crystal phase, but rather stay in the remaining glass phase of the glass ceramic. Contents that are too high have a detrimental effect on the crystallization behavior in the transformation of the crystallizable starting glass to the glass ceramic and have an unfavorable effect on the time/thermal stability of the glass ceramic.

Preferably, the Na2O content is 0 wt % or >0 wt % and, especially preferred, the glass ceramic contains at least 0.05 wt % Na2O and, more especially preferred, at least 0.07 wt % Na2O and, most especially preferred, 0.1 wt % Na2O. The maximum proportion is preferably 1 wt %.

Preferably, the K2O content is 0 wt % or >0 wt % and, especially preferred, the glass ceramic contains at least 0.1 wt % K2O. The maximum proportion is preferably 1 wt %.

The sum of the alkalis Na2O+K2O is further preferably at most 1.2 wt %. The sum of the alkalis Na2O+K2O is especially preferred at least 0.2 wt % in order to improve the meltability and to lower the processing temperature. Especially preferred, the following relation applies: 0.4 wt %≤Na2O+K2O≤1.2 wt %.

### Fe2O3

Preferably, the glass ceramic contains up to 0.06 wt % Fe2O3.

Because of the high costs of low-iron batch raw materials, it is not economical to limit the Fe2O3 content of the crystallizable glass to values below 0.008 wt %, that is, to less than 80 ppm. On the other hand, an increase in the Fe2O3 content is also associated with an increase in the concentration of the Fe/Ti color complexes in the glass ceramic and with a decrease in the perceptual lightness. For this reason, the crystallizable glass and the glass ceramic produced from it should contain preferably up to 0.06 wt % of Fe2O3, more preferably at most 0.025 wt %. That this relatively high iron content does not act too negatively on the perceptual lightness is an advantage of the glass ceramics and/or ceramization method described here. Contents of >600 ppm can result in the occurrence of an undesired reduction in the brightness in reflection, that is, in the perceptual lightness L*, as well as in an undesired color shift, that is, in a deviation of the neutral point in the a* and b* values and, in some cases, also in a reduction in the brightness Y.

### Nd2O3

Preferably, the glass ceramic contains no more than 0.065 wt % Nd2O3. Higher values can result in a decrease in the color value b*, as a result of which an undesired increase in the c* value can occur for otherwise low-color glass ceramics.

### P2O5

Preferentially, the glass ceramic contains 0 to 2 wt % P2O5, preferably 0 to 1 wt %, more preferably 0 to 0.5 wt %, most especially preferred 0 to 0.1 wt % P2O5.

For improvement of the meltability and resistance to devitrification in the forming, up to 2 wt % and preferably up to 1 wt % P2O5 can be present. Higher contents are disadvantageous for the chemical resistance.

Insofar as a proportion of 0 wt % is specified for components, this means that it is possible to dispense with the component in question in the raw material batch. However, these components can be present as unavoidable impurities.

### Bi2O3

In accordance with a further embodiment, the glass ceramics contain no Bi2O3 apart from impurities.

Bi2O3 is a coloring substance, which imparts to the glass ceramic a dark brown color. In order to achieve a perceptual lightness L* that is as high as possible, it is advantageous to exclude Bi2O3 in a targeted manner.

### ZrO2

Preferably, the glass ceramic contains up to 2.5 wt % ZrO2, in particular up to 2.4 wt %, more preferably up to 2.2 wt %. The upper limit of 2.5 wt % ensues from the demand of resistance to devitrification, in particular in the case when the glass ceramic has additional nucleating agents.

A minimum content of 1 wt % is required for a sufficiently fast nucleation.

In a preferred embodiment, both the crystallizable starting glass, which is also referred to as green glass, and the glass ceramic produced from the starting glass have preferably a composition that comprises the following components in the following proportions (in wt % based on oxide):

| | |
|---|---|
| TiO2 | >1.6-2.8 |
| ZrO2 | 1-2.5 |
| ZnO | 0-3 |
| MgO | 0.01-1 |
| SnO2 | 0.01-<0.3 |

with the condition B3a (both here in wt %)

0.005<MgO×SnO2<0.1.

The numerical values in condition B3a have the dimension (wt %)².

### MgO×SnO2

The product of the components MgO×SnO2 is ascribed a decisive importance in order to combine a low degree of color, a refinement capability, and low melting and forming temperatures. In this way, it is possible in economical production to lower further the color values a* and b* and to adjust correspondingly the brightness Y of the glass ceramic.

The glass according to the invention and thus also the glass ceramic according to the invention have a product of the components MgO×SnO2 (both in wt %) of preferably less than 0.1, preferably less than 0.08, preferably less than 0.07. The product of the components should be greater than 0.005, preferably greater than 0.01, more preferably greater than 0.012, and especially preferred greater than 0.015.

The condition B3a is advantageous in order to combine the desired favorable manufacturing properties of the glass with good color values a* and b* as well as with an adjustable brightness.

### TiO2/SnO2

Furthermore, in comparison to the prior art, an increased ratio of the nucleating agent TiO2/SnO2 with SnO2>0 wt % is advantageous. Preferably, the following relation holds: 7≤TiO2/SnO2<200 (condition B4). Further preferably, at least 8 and especially preferred at least 18 is valid for the ratio. Both components increase the color, in particular via the absorption of the Sn/Ti color complexes. Owing to the low SnO2 contents in accordance with the invention, the concentration of these color complexes decreases and the desired high brightness and low color are achieved. The TiO2 content can here be chosen to be at higher values and the ratio increases. In this way, it is possible to set short ceramization times and the resistance to devitrification is improved.

A preferred upper limit lies below 100, more preferably below 50, in particular below 40.

### TiO2+ZrO2+SnO2

Preferably, for the sum of the nucleating agents TiO2+ZrO2+SnO2, a value range of 3 to 4.8 wt % (condition B5) is valid. The minimum content is required for an adequately fast nucleation. Preferably, the minimum content is 3.5 wt % in order to be able, for fast ceramization, also to produce translucent glass ceramics with display capability. The upper limit of 4.8 wt % ensues from the demand for resistance to devitrification.

In accordance with a further embodiment, the glass ceramic has a composition that contains the following components (in wt % based on oxide):

| | |
|---|---|
| Li2O | 3.2-<4.5 |
| Al2O3 | 19-23 |
| SiO2 | 62-68 |
| Na2O | 0-1 |
| K2O | 0-1 |
| Na2O + K2O | 0.1-1.5 |
| ZnO | 0-3 |
| MgO | 0.01-1 |
| CaO | 0.05-2 |
| TiO2 | 1.8-2.8 |
| ZrO2 | 1-<2.2 |
| SnO2 | 0.01-<0.3 |
| TiO2 + ZrO2 + SnO2 | 3.5-4.8 |
| Fe2O3 | 0.008-0.06 |

with 0.005 < MgO × SnO2 < 0.1 (condition B3a)

In this preferred composition, ZnO can also necessarily be present. It then is valid that ZnO is preferably 1 to 3 wt %.

In accordance with a further embodiment, the glass ceramic has a composition that contains the following components (in wt % based on oxide):

| | |
|---|---|
| Li2O | 3.2-<4.5 |
| Al2O3 | 19-23 |
| SiO2 | 62-68 |
| Na2O | 0.05-1 |
| K2O | 0-1 |
| Na2O + K2O | 0.15-1.2 |
| MgO | 0.1-0.8 |
| CaO | 0.05-1 |
| SrO | 0-1.5 |
| BaO | 0-2.5 |
| SrO + BaO | 0.5-2.5 |
| ZnO | 1-2.9 |
| B2O3 | 0-1 |
| TiO2 | 1.8-2.8 |
| ZrO2 | 1-<2.2 |
| SnO2 | 0.01-<0.25 |
| TiO2 + ZrO2 + SnO2 | 3.6-4.8 |
| P2O5 | 0-2 |
| Fe2O3 | 0.008-0.05 |

with 0.005 < MgO × SnO2 < 0.1 (condition B3a)

Preferably, the glass ceramic, preferably the opaque or translucent glass ceramic, preferably in accordance with the variant A or B, is characterized in that, after an annealing of the glass ceramic over an annealing time of 10 h at 700° C., the brightness Y deviates by at most ±0.3 (|ΔY|≤0.3%), from the brightness Y prior to the annealing of the glass ceramic.

Preferably, the glass ceramic, preferably the opaque or translucent glass ceramic, preferably in accordance with the variant A or B, is characterized in that, after an annealing of the glass ceramic over an annealing time of 10 h at 700° C., the perceptual lightness L* deviates by at most ±1.5 (|ΔL*|≤1.5), preferably at most ±0.7 (|ΔL*|≤0.7), from the perceptual lightness L* prior to the annealing of the glass ceramic.

Preferably, the glass ceramic, preferably the opaque or translucent glass ceramic, preferably in accordance with the variant A or B, is characterized in that, after an annealing of the glass ceramic over an annealing time of 10 h at 700° C., the color value a* deviates by at most ±0.3 (|Δa*|≤0.3), from the color value a* prior to the annealing of the glass ceramic.

Preferably, the glass ceramic, preferably the opaque or translucent glass ceramic, preferably in accordance with the variant A or B, is characterized in that, after an annealing of the glass ceramic over an annealing time of 10 h at 700° C., the color value b* deviates by at most ±1.2 (|db*|≤1.2), preferably ±0.5 (|db*|≤0.5), from the color value b* prior to the annealing of the glass ceramic.

By use of this test over the relatively short annealing time of 10 h at a temperature that lies markedly above the application temperature, it is possible to simulate a long duration of use at lower application temperatures. The results of the test show that the optical properties Y and L*, a*, and b* of the tested glass ceramics, preferably of the opaque or translucent glass ceramics, are stable over a long period of time within narrow limits.

### Production Method of the Green Glass

The method for producing the crystallizable lithium aluminum silicate glasses is characterized by the steps:
a) preparation of a batch recipe from technical raw materials;
b) melting of the batch recipe and refinement at temperatures greater than 1600° C., preferably at temperatures greater than 1650° C.;
c) cooling of the glass melt and forming at temperatures in the vicinity of the processing temperature VA; and
d) cooling in a stress relief oven to room temperature, whereby undesired stresses in the glass are eliminated.

Room temperature is understood to mean 20° C.

After the method step b), it is also possible to carry out a high-temperature refinement at temperatures >1750° C.

The batch recipe is designed in such a way that, after the melting, glasses with the compositions and properties in accordance with the invention are formed. By way of a preferred shard addition of 20 to 80 wt % to the batch recipe, the melting is promoted and it is possible to obtain higher tank throughputs. As needed, a high-temperature refining assembly can be employed. In the forming, preferably a glass strip with a panel-shaped geometry is produced via rolling and is cooled in an annealing furnace to room temperature in order to prevent stresses. Panels of the desired size are produced from this glass strip after assurance of the quality in regard to volume and surface defects.

For an economical production, a low melting temperature is advantageous and is ensured by a lower viscosity of the glass melt at high temperatures.

It is advantageous economically to lower the temperature during the forming. The service lives of the forming tools are increased and there is less lost heat that needs to be dissipated. The forming, generally by rolling or floating, takes place at a viscosity of the glass melt of 10⁴ dPa s. This temperature is also referred to as the processing temperature VA.

In the forming from the melt, the crystallizable glass has an adequate resistance to devitrification. In the forming in contact with the forming material (for example, precious metal in the drawing nozzle in the rolling process), no crystals that are critical for the strength of the glass or visually noticeable crystals form in the glass. The limit temperature, below which critical devitrifications occur, that is, the upper devitrification limit (UDL), lies preferably below and especially preferred at least 15° C. below the processing temperature VA. For this minimum difference, an adequate process window is defined for the forming process. Especially advantageous is a process window VA-UDL that is at least 20° C. The difference in the temperatures VA-UDL is also a measure for the resistance to devitrification.

Suitable forming methods for the panel-shaped geometry are, in particular, rolling and floating. A preferred method of forming from the glass melt is a method over two rolls, because this method has advantages owing to the rapid cooling when the compositions exhibit a tendency to undergo devitrification.

### Ceramization Method

The next process step is the ceramization on flat or three-dimensionally shaped, high-temperature-stable supports (kiln furniture). Preferably, the ceramization is carried out in a roller kiln.

The method according to the invention for producing a glass ceramic, wherein a crystallizable As2O3-free and Sb2O3-free lithium aluminum silicate glass is provided, is characterized in that the ceramization is carried out using the following method steps in the following sequence:
a) increase of the temperature of the crystallizable glass from room temperature TRT to a temperature Ta, which lies in the range of 660 to 730° C., within 3 to 60 minutes;
b) increase of the temperature of the crystallizable glass from Ta to a temperature of at most 800° C. over a time period of 5 to 100 minutes;
c) increase of the temperature of the crystallization-seed-containing glass within 5 to 80 minutes duration in the temperature range Tb of beginning HQ-solid-solution formation from 780 to 850° C.;
d) residence in the temperature range Tb over a time period of 5 to 120 minutes;
e) increase of the temperature of the HQ-solid-solution-containing glass within 5 to 80 minutes duration in the temperature range TC of high crystal growth rate from 900° C. to 950° C.;
f) increase of the temperature of the HQ-solid-solution-containing glass within 5 to 80 minutes duration in the temperature range TD from 950° C. to 1250° C.;
g) residence in the temperature range TD over a residence time tV>0 to 60 minutes;
h) rapid cooling of the obtained glass ceramic to room temperature in less than 150 minutes;
   wherein the ceramization of the glass has a total duration of less than 300 min.

The temperature chosen in the temperature range TD is also referred to as the temperature TD and as the maximum temperature TD.

The crystallizable LAS glass can be SnO2-free or it can preferably contain SnO2.

In the method step d), the crystals of the high-quartz solid solution type grow on the crystallization seeds, consisting of nucleating agents. In this phase, in particular, the high-quartz solid solution structure is homogenized. This high-quartz solid solution structure influences the adjustability of the optical properties Y, L*, a*, and b*.

In the method step e), the growth of the high-quartz solid solutions progresses. The larger HQ solid solutions bring about an increasing light scattering.

In the method step f), crystals of the keatite solid solution type are formed from the crystals of the high-quartz solid solution type.

In the method step g), the crystals of keatite solid solution type mature further and the properties of the glass ceramic are optimized.

For optimization of the properties, preferably the following method steps are carried out in the method step g):

### First Embodiment

The keatite peak temperature lies preferably at TP 1005° C.

For production of a glass ceramic, in the method step g), preferably the following method step is carried out:
g11) residence at a temperature TD in the range of 1120° C. to 1180° C. over a residence time tV of 5 minutes to 20 minutes.

For production of a glass ceramic, in the method step g), preferably the following method step is carried out:
g12) residence at a temperature TD in the range of 1060° C. to 1120° C. over a residence time tV of 5 minutes to 20 minutes.

For production of a glass ceramic, in the method step g), preferably the following method step is carried out:
g13) residence at a temperature TD in the range of 1035° C. to 1080° C. over a residence time tV of 5 minutes to 20 minutes.

Preferably, at low temperatures TD, a longer residence time is chosen and vice versa.

The heat treatment in the steps g11) to g13) results in an optimization of the desired properties in the glass ceramic variants A to C, which can be produced by a short residence time tV and/or low temperatures TD in an economical manner.

### Second Embodiment

The keatite peak temperature lies preferably at TP>1005° C.

For production of a glass ceramic, in the method step g), preferably the following method step is carried out:
g21) residence at a temperature TD in the range of 1145° C. to 1180° C. over a residence time tV of 5 minutes to 20 minutes.

For production of a glass ceramic, in the method step g), preferably the following method step is carried out:
g22) residence at a temperature TD in the range of 1100° C. to 1150° C. over a residence time tV of 5 minutes to 20 minutes.

For production of a glass ceramic, in the method step g), preferably the following method step is carried out:
g23) residence at a temperature TD in the range of 1050° C. to 1100° C. over a residence time tV of 5 minutes to 20 minutes.

Preferably, at low temperatures TD, a longer residence time is chosen and vice versa.

The heat treatment in the steps g21) to g23 results in an optimization of the desired properties in the glass ceramic variants A to C, which can be produced by a short residence time tV and/or low temperatures TD in an economical manner.

Especially preferred embodiments for producing a glass ceramic that has a keatite peak temperature TP in the range of 990° C. to 1025° C., preferably in the range of 990° C. to 1005° C., relate to the following method steps:
g31) residence at a temperature TD of at least 1145° C. over a residence time tV of at least 6 minutes or at a temperature of at least 1120° C. of at least 15 min.
g32) residence at a temperature TD of at least 1100° C. over a residence time tV of at least 6 minutes or at a temperature of at least 1080° C. of at least 15 min.
g33) residence at a temperature TD of at least 1080° C. over a residence time tV of at least 6 minutes or at a temperature of at least 1065° C. of at least 15 min.

The heat treatment in the three mentioned preferred method steps g31) to g33) results likewise in an optimization of the desired properties in the glass ceramic variants A to C. The glass ceramic variants A to C as well as glass ceramics with preferably Y≤2% and L*≥93, produced according to g31), preferably 2%<Y≤10% and 80≤L*≤92, produced according to g32), as well as preferably 10%<Y≤25% and 62≤L*≤80, produced according to g33), can be produced by way of short residence times tV and/or low temperatures TD in an economical manner.

Additional especially preferred embodiments for producing a glass ceramic that has a keatite peak temperature TP in the range of >1005° C. to 1060° C., preferably in the range of 1015° C. to 1060° C., relate to the following method steps:
g41) residence at a temperature TD of at least 1170° C. over a residence time tV of at least 6 minutes or at a temperature of at least 1120° C. of at least 15 min.
g42) residence at a temperature TD of at least 1120° C. over a residence time tV of at least 6 minutes or at a temperature of at least 1100° C. of at least 15 min.
g43) residence at a temperature TD of at least 1100° C. over a residence time tV of at least 6 minutes or at a temperature of at least 1080° C. of at least 15 min.

The heat treatment in the steps g41) to g43) results likewise in an optimization of the desired properties in the glass ceramic variants A to C. The glass ceramic variants A to C as well as glass ceramics with preferably Y≤2% and L*≥90, produced according to g41), preferably 2%<Y≤10% and 80≤L*≤93, produced according to g42), as well as preferably 10%<Y≤25% and 67≤L*≤81, produced according to g43), can be produced by way of short residence times tV and/or low temperatures TD in an economical manner.

The object is also achieved by a glass ceramic according to one of claims 1 to 27, produced from a crystallizable As2O3-free and Sb2O3-free lithium aluminum silicate glass by a ceramization method according to one of claims 28 to 34.

The glass ceramic according to the invention, which is preferably in the form of a panel with a thickness of 2 mm to 20 mm, whereby the panel can be preferably burled or grooved on one side or smooth on both sides and/or can be deformed or bent, preferably finds use as a fire-protection glass, as a cooktop, such as, for example, as a cooktop for cooking appliances with inductive, radiative, or gas heating, as a covering in the lighting sector, as a support plate, or as an oven lining in baking ovens, fireplace ovens, or microwave appliances. The use can be intended for private household appliances of end users or for industrial applications, such as, for example, foodstuff/gastronomy applications. The glass ceramic can further find application in a large number of sizes and shapes as a grill cover and/or as gas burner or rotisserie burner covers or else as an accessory in the form of pizza stones or planchas.

It has been found that the glass ceramic is suitable for coatings. Preferably, the glass ceramic, in particular in the form of panels or plates, is furnished with a coating. Especially preferred are coatings that screen against thermal radiation.

The coating has a layer, preferably at least two layers. In the case of a coating with two layers, the first layer is preferably an IR-reflecting layer.

A preferred layer comprises a doped, transparent, conductive oxide. The oxide is preferably a zinc oxide. This layer is preferably used in a 2-layer system as the first layer.

Another preferred layer comprises an x-ray-amorphous oxide or nitride. Preferably, the oxide layer is an aluminum oxide layer. Preferably, the nitride layer is an aluminum nitride layer. This layer is preferably employed in a 2-layer system as the second layer, which is placed on the first layer.

It has been found that the keatite peak temperature TP can be influenced by the composition of the glass ceramic and the transformation temperature for the keatite formation, for which the keatite peak temperature is a measure, can be influenced by the ceramization conditions, as a result of which, in turn, the properties of the glass ceramic can be optimized.

### BRIEF DESCRIPTION OF THE DRAWINGS

Next, the present disclosure will be described in detail with reference to the appended drawing, wherein:

FIG. 1 is a schematic temperature/time diagram of a ceramization program, and drawn on the time axis t are the different method steps a) to h).

### DETAILED DESCRIPTION

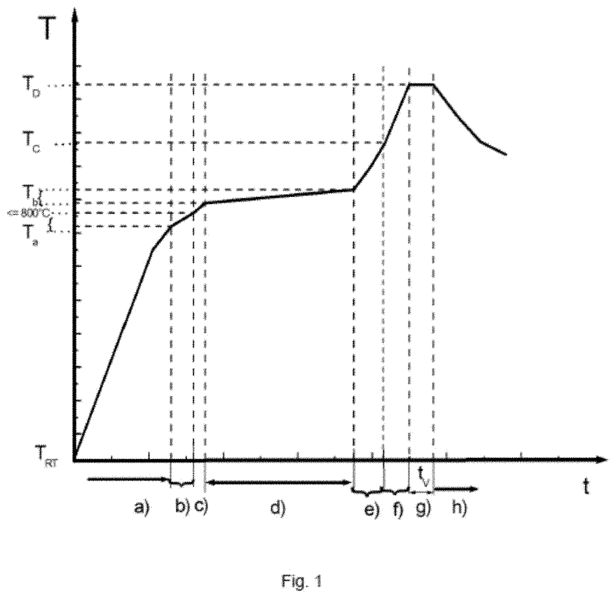

Exemplary embodiments will be explained below on the basis of FIG. 1 and from tables.

In the method step a), the green glass is heated from an initial temperature TRT with TRT=20° C. within 3 to 60 minutes to the temperature Ta. In the subsequent method step b), in which the nucleation takes place, there occurs a continuous increase in the temperature from Ta to a temperature of at most 800° C.

In the following step c), the temperature is increased to a temperature in the temperature range Tb. In this exemplary embodiment, the residence in the temperature range Tb in accordance with step d) is associated with a continuous temperature increase within this temperature range.

Afterwards, in accordance with step e), the temperature is raised within 5 to 80 minutes to a temperature in the temperature range TC. In the step f), a further increase in temperature is carried out from the temperature TC to a temperature in the temperature range TD, which extends from 950° C. to 1250° C.

When the temperature range TD is reached, the temperature in accordance with method step g) is held constant over a residence time tV. Which temperature TD and which residence time tV are preferably to be chosen in order to optimize the properties of the glass ceramics are described in connection with the various embodiments with the preferred method steps g11 to g43. Finally, in the method step h), there occurs a rapid cooling to room temperature.

Presented in Table 1 are preferred glass compositions that underwent the different ceramization methods 1, which are identified by the labels g11) to g13) or g21) to g23) in Tables 2 to 4. The ceramization methods 2, which are identified by g31 to g33 or g41 to g43, refer to special embodiments of the ceramization method 1. Which alternative of the respective ceramization method 2 is employed ensues from the specified TD and tv values.

Table1 shows the compositions of the crystallizable starting glasses according to the invention in wt % and the associated glass properties, such as the glass transition temperature Tg and the keatite peak temperature TP. The glass 14 here serves as a Comparative Example. The glass ceramics have the same compositions as the starting glasses.

The glasses were melted as follows:
a) preparation of a batch recipe from technical raw materials;
b) melting and refinement of the batch recipe on a laboratory scale in a silica glass crucible at 1620° C. with a subsequent holding time of 2 h, stirring at 1600° C. for 1 h for homogenization, increase of the temperature to 1640° C., and holding for 3 h;
c) production of a cast block; and
d) cooling in a stress relief oven to room temperature, whereby undesired stresses in the glass are eliminated.

Table 2 shows the optical properties of the glass ceramics according to the invention produced by means of a suitable ceramization method 1 (for example, g11 or g21) and of the comparative example of the variant A with Y≤2% (opaque glass ceramic) for a thickness of approximately 4 mm as well as the coefficients of mean linear thermal expansion.

The data show that the first embodiment, in comparison to the second embodiment, has higher perceptual lightness values L*, measured in reflection, for the same or similar brightness Y, measured in transmission, for the same ceramization method. This is clear, in particular, at lower maximum temperatures TD and shorter residence times tV. Furthermore, it can be seen that the comparative example, in comparison to the glass ceramics according to the invention, has a higher perceptual lightness L* at the same or similar brightness Y for the same ceramization method, in particular at high maximum temperatures TD as well as lower maximum temperatures TD and shorter residence times tV. It is assumed that this is associated with the As2O3 as refining agent, which acts in this glass ceramic as a “whitener.” At lower maximum temperatures TD and long residence times, however, embodiment 1, in comparison to embodiment 2 as well as in comparison to the comparative example, shows higher perceptual lightness L* at the same or similar brightness Y.

The glass ceramics according to the invention have the advantage that, in comparison to the comparative example, they have a lower coefficient of mean linear thermal expansion α̅(20° C.; 700° C.). This contributes to the thermoshock resistance of the glass ceramics.

Furthermore, it is noticeable that the two color values a* and b* as well as c* become smaller in absolute value with increasing perceptual lightness L* within an embodiment; that is, a* goes towards 0 and b* goes towards 0 and c* goes towards 0. The Nd2O3-containing examples here form within embodiment 2 for the color values b* as well as c* a separate group in the relationship between these color values and the perceptual lightness L*. In addition, it is especially noticeable that, in comparison to embodiment 2, embodiment 1 achieves, in terms of absolute value, lower color values b* as well as lower c* values at higher perceptual lightness values L*.

It becomes clear that Fe2O3 shifts the color value a* into the positive range, that is, towards red. It is to be noted here that, in regard to a*, this glass system appears to be insensitive to an increased Fe2O3 content, since, even in comparison to the comparative examples 26 to 28, it shows the same or even a smaller color value a* in terms of absolute value for the same ceramization method. In contrast to the color value a*, it is shown that, depending on the ceramization, the color value b* can be improved for the Fe2O3-rich glass ceramic or it can even be worsened. Thus, it can be ascertained that, for compositions with a higher Fe2O3 proportion, lower maximum temperatures TD and shorter residence times tV are to be favored in order to adjust both a* and b* in an optimal manner. However, attention needs to be paid here to the perceptual lightness L*, which drops at lower maximum temperatures TD and shorter residence times tV, in order to ensure a good white impression.

The addition of Nd2O3 in the glasses according to the invention, in contrast to the comparative examples that likewise contain Nd2O3, leads to an increase in absolute value of the color values a* and b* for the same ceramization method. In comparison to the other examples of embodiment 2 as well as in comparison to embodiment 1, the addition of Nd2O3 leads to a marked reduction in the color value b*, regardless of the ceramization method, for the same or similar color value a*.

In contrast to this, the increase in the SnO2 proportion, in particular in embodiment 1, results in the fact that the color values a* and b* become more distant from the so-called neutral point with a*=0 and b*=0.

Viewed overall, embodiment 1, in comparison to embodiment 2 and in comparison to the comparative examples, shows better color values a* and b* as well as c* for low SnO2 contents and for the absence of Nd2O3.

When the transmission values at 700 nm are regarded, it becomes clear that, in particular, the values of embodiment 2, in comparison to embodiment 1 as well as in comparison to the comparative examples, have higher values for the same ceramization method. The transmission at 700 nm is proportional to the brightness Y and therefore affords an indication for the brightness Y. The advantage here is that this value is directly measured.

It becomes especially clear for the glass ceramics according to the invention shown here that the infrared transmission at 1600 nm is markedly higher for both embodiments, apart from a few exceptions, in comparison to the comparative example for the same ceramization method.

The examples further show clearly that the addition of MgO leads to an increase in the perceptual lightness L* for comparable color values a* and b*. This lies in the fact that MgO helps to shift the keatite peak temperature to lower values (see Table 1) and accordingly a high perceptual lightness L* is more easily achieved. In addition, the addition of MgO leads to an increase in the transmission at 1600 nm.

Table 3 shows the optical properties of the glass ceramic according to the invention that was produced by means of a suitable ceramization method (g12 or g22) and of the comparative examples 64 and 65 of the variant B with Y>2% to 10% (translucent glass ceramic without display capability) for a thickness of approximately 4 mm as well as the coefficients of mean linear thermal expansion. The data reveal that, in this variant, too, higher perceptual lightness L* is achieved at the same or similar brightness Y for embodiment 1 in comparison to embodiment 2 for the same ceramization methods. In comparison to embodiment 1, the comparative examples achieve here, too, a higher perceptual lightness L* when the same ceramization methods are used. In addition, embodiment 1, in comparison to embodiment 2, already achieves a very good perceptual lightness L* at lower maximum temperatures TD, that is, even at 1120° C. instead of 1145° C.

The glass ceramics of this variant do not, in general, have a display capability. This is supported by the high quotient (PvK−PiP)/PiP at 630 nm, which is greater than 39. The examples 48 and 71 constitute an exception and were evaluated as “weak.” This optical impression obtained by visual inspection is confirmed by the low quotient (PvK−PiP)/PiP at 630 nm, namely, below 10.

The glass ceramics according to the invention have the advantage that, in comparison to the comparative examples, they have a lower coefficient of mean linear thermal expansion. This contributes to the thermoshock resistance of the glass ceramics.

In contrast to the variant A, variant B shows no clear relationship between the color values a* and b* as well as c* and the perceptual lightness L* within an embodiment, as described in connection with Table 2. However, this relationship is clearly shown within a composition. Thus, the color values a* and b* as well as c* decrease in absolute value with increasing L*. Furthermore, it can be ascertained that the addition of SnO2 in embodiment 1 leads to a marked increase in absolute value in the color values a* and b* as well as c* for the same or similar perceptual lightness L* for the same ceramization. When Fe2O3 is added, the perceptual lightness L* shifts clearly to lower values for the same or similar color values a* and c*.

As already described for the variant A, the variant B reveals that an increased Fe2O3 content in the glass ceramics according to the invention, in comparison to the comparative example 64, results in a lower color value a* in absolute value for the same ceramization method.

In the variant B, embodiment 1, in comparison to embodiment 2, has the advantage, regardless of the ceramization method, even at lower maximum temperatures TD, that the b* value for the same or similar a* value can be markedly increased. The color values a* and b* as well as c*, in comparison to the comparative examples for the same ceramization method, in particular at TD=1100° C., can be reduced in absolute value in the glass ceramics according to the invention, by reducing the coloring components SnO2 and Fe2O3. Thus, in comparison to the comparative examples, markedly improved (lower in terms of absolute amount) color values a* and b* as well as c* are achieved. On the basis of glass 12, it becomes clear that an increase in the maximum temperature TD and/or a prolongation of the residence time tV leads to the fact that the color values a* and b* as well as c* can be reduced in absolute value. This can be explained within this composition by an increasing perceptual lightness L* with an increase in the maximum temperature TD and/or with a prolongation of the residence time tV.

For the same ceramization method, both embodiments show higher transmission values at 700 nm and/or at 1600 nm in comparison to the comparative examples. For the same composition of the glass ceramic, the transmission values increase at 700 and 1600 nm with a dropping maximum temperature TD for the same residence time tv. On the basis of the glass 12, it could be shown that, for a prolongation of the residence time tV, the maximum temperature TD can be lowered, so that the same transmission values are produced for a comparable perceptual lightness L*.

Table 4 shows the optical properties of the glass ceramics according to the invention that were produced by means of a suitable ceramization method (g13 or g23) and of the comparative examples 95 and 96 of the variant C with Y>10% to 25% (translucent glass ceramic with display capability) for a thickness of approximately 4 mm as well as the coefficients of mean linear thermal expansion. As already shown for the other two variants A and B, embodiment 1 shows, in comparison to embodiment 2, higher perceptual lightness values L* at the same or similar brightness Y for the same ceramization method. In particular, it becomes clear here that, for embodiment 1, lower maximum temperatures TD are sufficient, in comparison to embodiment 2, to achieve comparable perceptual lightness values L*. However, higher brightnesses Y are achieved here, which favor a better display capability for red. Also, for this variant, the comparative example shows higher perceptual lightness values L* in comparison to both embodiments when the same ceramization methods are used.

In comparison to the comparative example, however, many examples show, for the same or higher perceptual lightness values L*, a better (good) display capability. This can be explained by the smaller quotient (PvK−PiP)/PiP at 630 nm, namely, 2.2 to 4.0, of the embodiments in comparison to 7.3 of the comparative example 96. In comparison to the comparative examples, both embodiment 1 and embodiment 2 show, for a very good display capability, higher perceptual lightness values L* for higher maximum temperatures TD and/or longer residence times tV. This improves the white impression in comparison to the comparative examples, whereas, although the comparative example shows a higher perceptual lightness L* at higher maximum temperatures TD, it still has only a weak display capability.

Higher brightnesses Y, but lower perceptual lightness values L* favor a very good display capability. Also in this display capability category, many examples show higher perceptual lightness values L* in comparison to the comparative examples, thereby favoring an improved white impression.

In the variant C as well, there is, within a glass composition, a clear relation between the color values a* and b* as well as c* and the perceptual lightness L*. The higher the latter is, the higher is the maximum temperature TD for same residence times tV, or the longer the residence time tV is for lower maximum temperatures TD, the lower in absolute value are also the color values a* and b* as well as c*.

As in the case of the other two variants A and B, it becomes clear here, too, that a reduction in the SnO2 content leads to an improvement (that is, a reduction in absolute value) of the color values a* and b* as well as c* for the same ceramization method.

In comparison to the comparative examples, embodiment 1 shows, for the same ceramization method and for a reduction in the SnO2 content, markedly better color values a* and b* as well as c*, even though the perceptual lightness L* is markedly smaller in comparison to the comparative examples for the same ceramization method. This means that a further improvement in the color values a* and b* as well as c* is possible for a marked increase in the perceptual lightness values L* with an increase in the maximum temperature TD or a prolongation of the residence time tV for the same maximum temperature TD. This example highlights the fact that, with a suitable composition, no impairment in the color values a* and b* as well as c* occurs through the use of SnO2 as refining agent.

Similar or even better color values a* and b* as well as c*, in comparison to embodiment 1, can also be achieved with embodiment 2. To this end, however, higher maximum temperatures TD and/or longer residence times tV are needed.

In contrast to the comparative examples, for the same ceramization method, a comparable or even better display capability is achieved in embodiment 1.

In comparison to embodiment 1, embodiment 2 enables a good display capability to be achieved even at higher maximum temperatures TD. However, it is possible with embodiment 1, in comparison to embodiment 2, to achieve comparable or even higher perceptual lightness values L* for an equally good display capability even at lower maximum temperatures TD and/or longer residence times tV, as a result of which the white impression of embodiment 1, in comparison to embodiment 2, can be adjusted in a more energy-efficient manner.

Furthermore, the variant C, as also in the case of the other two variants A and B, shows within a composition an increasing transmission at 700 and/or 1600 nm at lower maximum temperatures TD and the same residence time tV. For the same ceramization method, the comparative examples, in comparison to embodiment 1, have a higher transmission at 700 and/or 1600 nm. However, both examples of embodiment 1 and embodiment 2 show, at higher maximum temperatures TD and/or longer residence times tV, an increased transmission at 700 and/or 1600 nm in comparison to the comparative examples.

In addition, the examples show that the removal of MgO from the composition in the variant C leads to a markedly color-neutral glass ceramic (color values a*, b*, and c* reduced in absolute value) for a comparable perceptual lightness L*. As already shown for the examples of variant A, the addition of MgO also leads in variant C to an increase in the transmission at 1600 nm, but also at 630 as well as at 700 nm.

The increase in SnO2 for a better refinement of the glass melt, in comparison to a lower SnO2 content in a suitable composition, leads to comparable color values a*, b*, and c* for a comparable perceptual lightness L*.

Table 5 shows that an annealing of the glass ceramics according to the invention with a thickness of approximately 4 mm of the variants A (embodiment 1) and B (embodiment 2) at 700° C. over an annealing time of 10 h causes no shift or only a negligible shift in the brightness Y, in the perceptual lightness L*, and in the color values a* and b*. Accordingly, in comparison to the comparative example, there is no drawback due to the use of SnO2 as a refining agent.

TABLE 1
Composition

| | | 1 | 2 | 3 | 4 | 5 | 6 |
|---|---|---|---|---|---|---|---|
| Glass | | | | | | | |
| Li2O | wt. % | 3.69 | 3.70 | 3.74 | 3.72 | 3.70 | 3.68 |
| Na2O | wt. % | 0.14 | 0.14 | 0.14 | 0.14 | 0.14 | 0.14 |
| K2O | wt. % | 0.33 | 0.33 | 0.33 | 0.33 | 0.33 | 0.33 |
| MgO | wt. % | 0.32 | 0.32 | 0.32 | 0.32 | 0.50 | 0.32 |
| CaO | wt. % | 0.31 | 0.31 | 0.31 | 0.31 | 0.31 | 0.31 |
| SrO | wt. % | 0.051 | 0.062 | 0.045 | 0.051 | 0.050 | 0.050 |
| BaO | wt. % | 1.00 | 0.99 | 0.99 | 0.99 | 0.98 | 0.99 |
| ZnO | wt. % | 1.86 | 1.84 | 1.84 | 1.87 | 1.85 | 2.07 |
| Al2O3 | wt. % | 21.40 | 21.42 | 21.34 | 20.41 | 20.39 | 21.41 |
| SiO2 | wt. % | 66.50 | 66.40 | 66.50 | 67.50 | 67.60 | 66.50 |
| TiO2 | wt. % | 2.43 | 2.43 | 2.42 | 2.43 | 2.21 | 2.22 |
| ZrO2 | wt. % | 1.85 | 1.85 | 1.84 | 1.85 | 1.84 | 1.86 |
| P2O5 | wt. % | 0.038 | 0.034 | 0.031 | 0.032 | 0.030 | 0.031 |
| SnO2 | wt. % | 0.07 | 0.07 | 0.07 | 0.07 | 0.09 | 0.07 |
| Fe2O3 | wt. % | 0.014 | 0.05 | 0.014 | 0.014 | 0.014 | 0.014 |
| Nd2O3 | wt. % | | | 0.056 | | | |
| As2O3 | wt. % | | | | | | |
| Σ | wt. % | 100.00 | 99.95 | 99.99 | 100.04 | 100.03 | 100.0 |
| MgO × SnO2 | wt. | 0.02 | 0.02 | 0.02 | 0.02 | 0.04 | 0.02 |
| TiO2/SnO2 | | 34.23 | 33.75 | 34.08 | 33.75 | 25.11 | 31.27 |
| TiO2 + ZrO2 + | wt. % | 4.35 | 4.35 | 4.33 | 4.35 | 4.14 | 4.15 |
| Na2O + K2O | wt. % | 0.47 | 0.48 | 0.47 | 0.47 | 0.47 | 0.47 |
| Na2O/K2O | | 0.42 | 0.43 | 0.42 | 0.42 | 0.42 | 0.42 |
| SrO + BaO | wt. % | 1.05 | 1.05 | 1.04 | 1.04 | 1.03 | 1.04 |
| SiO2/Al2O3 | | 3.11 | 3.10 | 3.12 | 3.31 | 3.32 | 3.11 |
| Al2O3/(Li2O + | | 3.65 | 3.66 | 3.62 | 3.45 | 3.37 | 3.53 |
| MgO + ZnO) | | | | | | | |
| Glass | | | | | | | |
| [symbol] | | | | | | | |
| Tg | ° C. | 687 | 686 | 680 | 687 | 686 | 686 |
| Keatite peak | ° C. | 1043 | 1044 | 1044 | 1030 | 1032 | 1048 |
| [symbol] | | | | | | | |
| | | 7 | 8 | 9 | 10 | 11 | 12 |
| Glass | | | | | | | |
| Li2O | wt. % | 3.71 | 3.75 | 3.73 | 3.72 | 3.72 | 4.22 |
| Na2O | wt. % | 0.14 | 0.13 | 0.14 | 0.14 | 0.13 | 0.22 |
| K2O | wt. % | 0.33 | 0.33 | 0.33 | 0.33 | 0.33 | |
| MaO | wt. % | 0.31 | 0.31 | 0.49 | 0.31 | 0.49 | 0.40 |
| CaO | wt. % | 0.31 | 0.31 | 0.31 | 0.31 | 0.31 | 0.43 |
| SrO | wt. % | 0.051 | 0.050 | 0.050 | 0.050 | 0.050 | 0.010 |
| BaO | wt. % | 0.98 | 0.99 | 0.99 | 0.99 | 0.99 | 1.02 |
| ZnO | wt. % | 2.26 | 2.16 | 1.87 | 2.05 | 2.05 | 2.71 |
| Al2O3 | wt. % | 21.34 | 21.42 | 21.41 | 20.40 | 20.40 | 22.48 |
| SiO2 | wt. % | 66.60 | 66.60 | 67.00 | 67.50 | 67.50 | 64.60 |
| TiO2 | wt. % | 2.02 | 1.92 | 1.92 | 2.23 | 2.01 | 1.92 |
| ZrO2 | wt. % | 1.85 | 1.84 | 1.65 | 1.86 | 1.86 | 1.84 |
| P2O5 | wt. % | 0.030 | 0.029 | 0.029 | 0.031 | 0.028 | 0.028 |
| SnO2 | wt. % | 0.07 | 0.07 | 0.07 | 0.07 | 0.07 | 0.09 |
| Fe2O3 | wt. % | 0.014 | 0.014 | 0.014 | 0.014 | 0.014 | 0.015 |
| Nd2O3 | wt. % | | | | | | |
| As2O3 | wt. % | | | | | | |
| Σ | wt. % | 100.02 | 99.93 | 100.00 | 100.00 | 99.95 | 99.98 |
| MgO × SnO2 | wt. %² | 0.02 | 0.02 | 0.03 | 0.02 | 0.03 | 0.04 |
| TiO2/SnO2 | | 29.28 | 27.47 | 28.24 | 31.80 | 28.32 | 20.68 |
| Ti02 + ZrO2 | wt. % | 3.94 | 3.83 | 3.64 | 4.16 | 3.94 | 3.86 |
| Na2O + K2O | wt. % | 0.47 | 0.46 | 0.47 | 0.47 | 0.46 | 0.22 |
| Na2O/K2O | | 0.42 | 0.40 | 0.41 | 0.43 | 0.39 | — |
| SrO + BaO | wt. % | 1.03 | 1.04 | 1.04 | 1.04 | 1.04 | 1.03 |
| SiO2/Al2O3 | | 3.12 | 3.11 | 3.13 | 3.31 | 3.31 | 2.87 |
| Al2O3/ | | 3.40 | 3.44 | 3.51 | 3.36 | 3.26 | 3.07 |
| (Li2O + MgO | | | | | | | |
| Glass | | | | | | | |
| [symbol] | | | | | | | |
| Tg | ° C. | 685 | 690 | 689 | 684 | 685 | 679 |
| Keatite peak | ° C. | 1041 | 1040 | 1037 | 1031 | 1036 | 996 |
| [symbol] | | | | | | | |
| | | 13 | 14 | 15 | 16 | 17 | 18 |
| Glass | | | | | | | |
| Li2O | wt. % | 3.88 | 3.71 | 3.91 | 3.64 | 3.81 | 3.66 |
| Na2O | wt. % | 0.12 | 0.15 | 0.15 | 0.15 | 0.14 | 0.17 |
| K2O | wt. % | 0.20 | 0.20 | 0.33 | 0.32 | 0.42 | 0.31 |
| MgO | wt. % | 0.40 | 1.07 | 0.32 | 0.32 | 0.33 | 0.29 |
| CaO | wt. % | 0.33 | 0.02 | 0.31 | 0.25 | 0.25 | 0.41 |
| SrO | wt. % | 0.009 | 0.008 | 0.050 | 0.500 | 0.300 | 0.055 |
| BaO | wt. % | 1.03 | 0.83 | 0.99 | 0.55 | 1.01 | 0.95 |
| ZnO | wt. % | 2.14 | 1.61 | 2.06 | 1.94 | 2.04 | 2.04 |
| Al2O3 | wt. % | 21.55 | 20.13 | 20.47 | 21.70 | 21.66 | 21.73 |
| SiO2 | wt. % | 66.40 | 67.10 | 67.50 | 66.40 | 66.10 | 66.30 |
| TiO2 | wt. % | 1.94 | 2.38 | 1.92 | 2.20 | 1.92 | 2.07 |
| ZrO2 | wt. % | 1.86 | 1.80 | 1.85 | 1.85 | 1.85 | 1.84 |
| P2O5 | wt. % | 0.029 | 0.029 | 0.029 | 0.030 | 0.028 | 0.029 |
| SnO2 | wt. % | 0.09 | | 0.07 | 0.07 | 0.07 | 0.07 |
| Fe2O3 | wt. % | 0.015 | 0.018 | 0.014 | 0.015 | 0.015 | 0.013 |
| Nd2O3 | wt. % | | 0.060 | | 0.047 | 0.059 | 0.048 |
| As2O3 | wt. % | | 0.820 | | | | |
| Σ | wt. % | 99.99 | 99.94 | 99.97 | 99.99 | 100.00 | 99.98 |
| MgO × SnO2 | wt. %² | 0.04 | 0.00 | 0.02 | 0.02 | 0.02 | 0.02 |
| TiO2/SnO2 | | 21.56 | — | 25.89 | 31.94 | 27.04 | 30.90 |
| TiO2 + ZrO2 | wt. % | 3.89 | 4.18 | 3.84 | 4.12 | 3.84 | 3.98 |
| Na2O + K2O | wt. % | 0.32 | 0.35 | 0.48 | 0.48 | 0.57 | 0.48 |
| Na2O/K2O | | 0.59 | 0.76 | 0.45 | 0.48 | 0.34 | 0.53 |
| SrO + BaO | wt. % | 1.04 | 0.84 | 1.04 | 1.05 | 1.31 | 1.01 |
| SiO2/Al2O3 | | 3.08 | 3.33 | 3.30 | 3.06 | 3.05 | 3.05 |
| Al2O3/ | | 3.36 | 3.15 | 3.26 | 3.68 | 3.51 | 3.63 |
| (Li2O + MgO | | | | | | | |
| Glass | | | | | | | |
| [symbol] | | | | | | | |
| Tg | ° C. | 687 | 682 | 684 | 689 | 684 | 688 |
| Keatite peak | ° C. | 1030 | 1021 | 1024 | 1052 | 1029 | 104 |
| [symbol] | | | | | | | |

| | | 19 | 20 | 21 | 22 |
|---|---|---|---|---|---|
| Glass | | | | | |
| Li2O | wt. % | 3.98 | 4.00 | 4.12 | 3.82 |
| Na2O | wt. % | 0.08 | 0.08 | 0.15 | 0.16 |
| K2O | wt. % | 0.42 | 0.52 | 0.32 | 0.33 |
| MgO | wt. % | 0.34 | 0.39 | 0.34 | 0.43 |
| CaO | wt. % | 0.37 | 0.37 | 0.37 | 0.37 |
| SrO | wt. % | 0.050 | 0.150 | 0.053 | 0.051 |
| BaO | wt. % | 1.10 | 1.09 | 1.10 | 1.19 |
| ZnO | wt. % | 2.18 | 1.99 | 2.12 | 2.16 |
| Al2O3 | wt. % | 20.00 | 20.44 | 20.52 | 20.51 |
| SiO2 | wt. % | 67.40 | 67.00 | 66.90 | 67.00 |
| TiO2 | wt. % | 1.93 | 1.92 | 1.90 | 1.94 |
| ZrO2 | wt. % | 1.91 | 1.91 | 1.86 | 1.91 |
| P2O5 | wt. % | 0.028 | 0.029 | 0.029 | 0.028 |
| SnO2 | wt. % | 0.22 | 0.07 | 0.17 | 0.12 |
| Fe2O3 | wt. % | 0.014 | 0.014 | 0.014 | 0.014 |
| Nd2O3 | wt. % | | | | |
| As2O3 | wt. % | | | | |
| Σ | wt. % | 100.01 | 99.97 | 99.97 | 100.02 |
| MgO × | wt. %² | 0.08 | 0.03 | 0.06 | 0.05 |
| TiO2/ | | 8.68 | 25.95 | 10.94 | 15.74 |
| TiO2 + | wt. % | 4.06 | 3.90 | 3.94 | 3.97 |
| Na2O + | wt. % | 0.49 | 0.60 | 0.48 | 0.48 |
| Na2O/ | | 0.19 | 0.15 | 0.47 | 0.48 |
| SrO + BaO | wt. % | 1.15 | 1.24 | 1.15 | 1.24 |
| SiO2/ | | 3.37 | 3.28 | 3.26 | 3.27 |
| Al2O3/ | | 3.08 | 3.21 | 3.12 | 3.20 |
| (Li2O + | | | | | |
| Glass | | | | | |
| [symbol] | | | | | |
| Tg | ° C. | 676 | 679 | 676 | 682 |
| Keatite | ° C. | 1002 | 1008 | 995 | 1019 |
| [symbol] | | | | | |

| | | 23 | 24 | 25 | 26 |
|---|---|---|---|---|---|
| Glass | | | | | |
| Li2O | wt. % | 4.04 | 4.15 | 3.70 | 4.18 |
| Na2O | wt. % | 0.13 | 0.14 | 0.14 | 0.15 |
| K2O | wt. % | 0.33 | 0.32 | 0.33 | 0.33 |
| MgO | wt. % | 0.32 | 0.33 | 0.32 | 0.33 |
| CaO | wt. % | 0.31 | 0.37 | 0.31 | 0.37 |
| SrO | wt. % | 0.052 | 0.051 | 0.052 | 0.052 |
| BaO | wt. % | 0.99 | 1.10 | 0.99 | 1.10 |
| ZnO | wt. % | 1.91 | 2.05 | 1.85 | 2.11 |
| Al2O3 | wt. % | 21.49 | 21.54 | 20.29 | 20.39 |
| SiO2 | wt. % | 66.40 | 66.10 | 67.60 | 67.10 |
| TiO2 | wt. % | 2.03 | 1.91 | 2.43 | 1.90 |
| ZrO2 | wt. % | 1.85 | 1.86 | 1.85 | 1.85 |
| P2O5 | wt. % | 0.028 | 0.027 | 0.030 | 0.027 |
| SnO2 | wt. % | 0.07 | 0.07 | 0.08 | 0.07 |
| Fe2O3 | wt. % | 0.015 | 0.015 | 0.014 | 0.015 |
| Nd2O3 | wt. % | 0.021 | | | |
| As2O3 | wt. % | | | | |
| Σ | wt. % | 99.96 | 100.04 | 100.01 | 99.97 |
| MgO × | wt. % | 0.02 | 0.02 | 0.03 | 0.02 |
| SnO2 | | | | | |
| TiO2/ | 29.03 | 28.49 | 31.15 | 26.82 | |
| SnO2 | | | | | |
| TiO2 + | wt. % | 3.95 | 3.84 | 4.36 | 3.83 |
| ZrO2 + | | | | | |
| SnO2 | | | | | |
| Na2O + | wt. % | 0.46 | 0.47 | 0.47 | 0.47 |
| K2O | | | | | |
| Na2O/ | 0.40 | 0.44 | 0.41 | 0.45 | |
| K2O | | | | | |
| SrO + BaO | wt. % | 1.04 | 1.15 | 1.04 | 1.15 |
| SiO2/ | 3.09 | 3.07 | 3.33 | 3.29 | |
| Al2O3 | | | | | |
| Al2O3/ | 3.43 | 3.30 | 3.46 | 3.08 | |
| (Li2O + | | | | | |
| MgO + | | | | | |
| ZnO) | | | | | |
| Glass | | | | | |
| properties | | | | | |
| Tg | ° C. | 684 | 676 | | |
| Keatite | ° C. | 1022 | 1012 | >1005 | ≤1005 |
| solid | | | | | |
| solution | | | | | |
| peak | | | | | |
| temperature | | | | | |

| | | 27 | 28 | 29 | 30 | 31 |
|---|---|---|---|---|---|---|
| Glass | | | | | | |
| Li2O | wt. % | 4.15 | 4.17 | 4.18 | 4.01 | 4.15 |
| Na2O | wt. % | 0.24 | 0.14 | 0.14 | 0.12 | 0.13 |
| K2O | wt. % | 0.32 | 0.32 | 0.33 | 0.33 | 0.32 |
| MgO | wt. % | 0.33 | | | 0.32 | 0.33 |
| CaO | wt. % | 0.37 | 0.36 | 0.36 | 0.31 | 0.36 |
| SrO | wt. % | 0.050 | 0.067 | 0.237 | 0.050 | 0.051 |
| BaO | wt. % | 1.09 | 1.38 | 1.21 | 1.00 | 1.11 |
| ZnO | wt. % | 2.13 | 2.14 | 2.16 | 2.03 | 2.14 |
| Al2O3 | wt. % | 20.36 | 20.44 | 20.49 | 20.39 | 20.52 |
| SiO2 | wt. % | 67.00 | 67.00 | 66.90 | 67.50 | 66.90 |
| TiO2 | wt. % | 1.91 | 1.90 | 1.91 | 1.93 | 1.90 |
| ZrO2 | wt. % | 1.85 | 1.86 | 1.86 | 1.87 | 1.86 |
| P2O5 | wt. % | 0.027 | 0.027 | 0.027 | 0.030 | 0.027 |
| SnO2 | wt. % | 0.17 | 0.17 | 0.17 | 0.07 | 0.17 |
| Fe2O3 | wt. % | 0.014 | 0.014 | 0.014 | 0.014 | 0.014 |
| Nd2O3 | wt. % | | 0.023 | | 0.015 | 0.023 |
| As2O3 | wt. % | | | | | |
| Σ | wt. % | 100.02 | 100.01 | 99.98 | 99.99 | 100.01 |
| MgO × | wt. % | 0.06 | 0.00 | 0.00 | 0.02 | 0.06 |
| TiO2/ | | 11.16 | 11.18 | 11.10 | 27.13 | 11.25 |
| TiO2 + | wt. % | 3.93 | 3.93 | 3.94 | 3.87 | 3.93 |
| Na2O + | wt. % | 0.57 | 0.46 | 0.46 | 0.45 | 0.45 |
| Na2O/ | | 0.76 | 0.43 | 0.43 | 0.38 | 0.40 |
| SrO + BaO | wt. % | 1.14 | 1.45 | 1.45 | 1.05 | 1.16 |
| SiO2/ | | 3.29 | 3.28 | 3.27 | 3.31 | 3.26 |
| Al2O3/ | | 3.08 | 3.24 | 3.23 | 3.20 | 3.10 |
| (Li2O + | | | | | | |
| Glass | | | | | | |
| properties | | | | | | |
| Tg | ° C. | | | | | |
| Keatite | ° C. | <1005 | >1005 | >1005 | >1005 | <1005 |
| solid | | | | | | |

| | | 32 | 33 | 34 | 35 | 36 | 37 |
|---|---|---|---|---|---|---|---|
| Glass | | | | | | | |
| Li2O | wt. % | 4.17 | 3.84 | 3.83 | 3.79 | 3.81 | 3.65 |
| Na2O | wt. % | 0.13 | 0.26 | 0.25 | 0.06 | 0.26 | 0.25 |
| K2O | wt. % | 0.32 | 0.23 | 0.24 | 0.23 | 0.24 | 0.24 |
| MaO | wt. % | 0.34 | 0.32 | 0.33 | 0.32 | 0.32 | 0.32 |
| CaO | wt. % | 0.37 | 0.31 | 0.31 | 0.31 | 0.31 | 0.31 |
| SrO | wt. % | 0.23 | 0.251 | 0.252 | 0.251 | 0.250 | 0.24 |
| BaO | wt. % | 0.94 | 0.80 | 0.80 | 0.80 | 0.80 | 0.80 |
| ZnO | wt. % | 2.16 | 1.87 | 1.87 | 1.84 | 1.87 | 1.84 |
| Al2O3 | wt. % | 20.4 | 20.45 | 20.53 | 20.31 | 20.38 | 20.4 |
| SiO2 | wt. % | 66.8 | 67.30 | 67.10 | 67.20 | 67.30 | 67.4 |
| TiO2 | wt. % | 1.91 | 2.41 | 2.40 | 2.41 | 2.42 | 2.43 |
| ZrO2 | wt. % | 1.86 | 1.86 | 1.86 | 2.24 | 1.86 | 1.86 |
| P2O5 | wt. % | 0.02 | 0.029 | 0.029 | 0.029 | 0.031 | 0.03 |
| SnO2 | wt. % | 0.17 | 0.07 | 0.12 | 0.07 | 0.11 | 0.07 |
| Fe2O3 | wt. % | 0.01 | 0.015 | 0.014 | 0.014 | 0.014 | 0.01 |
| Nd2O3 | wt. % | | 0.022 | 0.025 | 0.053 | 0.050 | 0.02 |
| As2O3 | wt. % | | | | | | |
| Σ | wt. % | 99.9 | 100.03 | 99.95 | 99.92 | 100.02 | 99.9 |
| MgO × | wt. % | 0.06 | 0.02 | 0.04 | 0.02 | 0.04 | 0.02 |
| TiO2/ | | 11.0 | 37.08 | 20.34 | 35.44 | — | 35.7 |
| TiO2 + | wt. % | 3.94 | 4.34 | 4.38 | 4.72 | 4.39 | 4.36 |
| Na2O + | wt. % | 0.45 | 0.49 | 0.49 | 0.29 | 0.49 | 0.49 |
| Na2O/ | | 0.40 | 1.09 | — | 0.24 | 1.07 | 1.06 |
| SrO + | wt. % | 1.17 | 1.05 | 1.05 | 1.05 | 1.05 | 1.05 |
| SiO2/ | | 3.26 | 3.29 | 3.27 | 3.31 | 3.30 | 3.29 |
| Al2O3 / | | 3.07 | 3.39 | 3.41 | 3.41 | 3.40 | 3.53 |
| (Li2O + | | | | | | | |
| [symbol] | | | | | | | |
| Glass | | | | | | | |
| properties | | | | | | | |
| Tg | ° C. | | | 682 | | | |
| Keatite | ° C. | ≤1005 | 1029 | 1027 | >1005 | >1005 | 1051 |
| solid | | | | | | | |

| | | 38 | 39 | 40 | 41 | 42 |
|---|---|---|---|---|---|---|
| Glass | | | | | | |
| Li2O | wt. % | 3.66 | 3.81 | 3.85 | 3.85 | 3.79 |
| Na2O | wt. % | 0.24 | 0.25 | 0.25 | 0.25 | 0.24 |
| K2O | wt. % | 0.24 | 0.24 | 0.23 | 0.24 | 0.23 |
| MgO | wt. % | 0.32 | 0.32 | 0.32 | 0.32 | 0.32 |
| CaO | wt. % | 0.31 | 0.31 | 0.31 | 0.30 | 0.31 |
| SrO | wt. % | 0.252 | 0.252 | 0.250 | 0.251 | 0.248 |
| BaO | wt. % | 0.80 | 0.81 | 0.81 | 0.80 | 0.80 |
| ZnO | wt. % | 1.84 | 2.24 | 2.24 | 2.22 | 2.23 |
| Al2O3 | wt. % | 20.43 | 21.49 | 21.41 | 21.45 | 21.40 |
| SiO2 | wt. % | 67.40 | 66.30 | 66.20 | 66.20 | 66.30 |
| TiO2 | wt. % | 2.43 | 2.02 | 2.02 | 2.04 | 2.01 |
| ZrO2 | wt. % | 1.86 | 1.85 | 1.85 | 1.85 | 1.86 |
| P2O5 | wt. % | 0.029 | 0.026 | 0.027 | 0.027 | 0.027 |
| SnO2 | wt. % | 0.09 | 0.07 | 0.12 | 0.07 | 0.12 |
| Fe2O3 | wt. % | 0.014 | 0.014 | 0.014 | 0.014 | 0.014 |
| Nd2O3 | wt. % | 0.024 | 0.025 | 0.026 | 0.054 | 0.052 |
| As2O3 | wt. % | | | | | |
| Σ | wt. % | 99.94 | 100.02 | 99.93 | 99.92 | 99.95 |
| MgO × | wt. % | 0.03 | 0.02 | 0.04 | 0.02 | 0.04 |
| TiO2/ | | 26.70 | 28.84 | 16.97 | 30.85 | 17.07 |
| TiO2 + | wt. % | 4.38 | 3.94 | 3.99 | 3.95 | 3.99 |
| Na2O + | wt. % | 0.48 | 0.48 | 0.48 | 0.48 | 0.47 |
| Na2O/ | | 1.03 | 1.03 | 1.06 | 1.06 | 1.01 |
| SrO + | wt. % | 1.05 | 1.06 | 1.06 | 1.05 | 1.05 |
| SiO2/ | | 3.30 | 3.09 | 3.09 | 3.09 | 3.10 |
| Al2O3/ | | 3.51 | 3.37 | 3.34 | 3.36 | 3.38 |
| (Li2O + | | | | | | |
| [symbol] | | | | | | |
| Glass | | | | | | |
| properties | | | | | | |
| Tg | ° C. | 691 | | 687 | | |
| Keatite | ° C. | 1049 | 1032 | 1031 | >1005 | >1005 |
| solid | | | | | | |
| | | 43 | 44 | 45 | 46 | 47 |
| Glass | | | | | | |
| Li2O | wt. % | 3.84 | 3.87 | 3.84 | 3.85 | 3.73 |
| Na2O | wt. % | 0.24 | 0.25 | 0.25 | 0.24 | 0.24 |
| K2O | wt. % | 0.32 | 0.32 | 0.32 | 0.31 | 0.23 |
| MgO | wt. % | 0.33 | 0.33 | 0.33 | 0.33 | 0.31 |
| CaO | wt. % | 0.25 | 0.25 | 0.24 | 0.25 | 0.31 |
| SrO | wt. % | 0.290 | 0.293 | 0.291 | 0.291 | 0.252 |
| BaO | wt. % | 1.02 | 1.02 | 1.02 | 1.03 | 0.80 |
| ZnO | wt. % | 2.03 | 2.05 | 2.00 | 2.01 | 1.84 |
| Al2O3 | wt. % | 21.68 | 21.68 | 21.66 | 21.66 | 20.49 |
| SiO2 | wt. % | 66.10 | 65.90 | 66.10 | 66.00 | 67.30 |
| TiO2 | wt. % | 1.91 | 1.92 | 1.91 | 1.92 | 2.41 |
| ZrO2 | wt. % | 1.85 | 1.86 | 1.85 | 1.85 | 1.86 |
| P2O5 | wt. % | 0.027 | 0.027 | 0.027 | 0.026 | 0.029 |
| SnO2 | wt. % | 0.07 | 0.12 | 0.07 | 0.12 | 0.07 |
| Fe2O3 | wt. % | 0.015 | 0.015 | 0.015 | 0.015 | 0.014 |
| Nd2O3 | wt. % | 0.023 | 0.019 | 0.053 | 0.053 | 0.051 |
| As2O3 | wt. % | | | | | |
| Σ | wt. % | 99.99 | 99.93 | 99.97 | 99.95 | 99.94 |
| MgO × | wt. % | 0.02 | 0.04 | 0.02 | 0.04 | 0.02 |
| TiO2/ | | 26.49 | 15.61 | 27.34 | 16.38 | 36.52 |
| TiO2 + | wt. % | 3.83 | 3.90 | 3.83 | 3.88 | 4.34 |
| Na20 + | wt. % | 0.56 | 0.57 | 0.56 | 0.56 | 0.48 |
| Na2O/ | | 0.75 | 0.78 | 0.78 | 0.78 | 1.04 |
| SrO + | wt. % | 1.31 | 1.31 | 1.31 | 1.32 | 1.05 |
| SiO2/ | | 3.05 | 3.04 | 3.05 | 3.05 | 3.28 |
| Al2O3/ | | 3.50 | 3.47 | 3.51 | 3.50 | 3.48 |
| (Li2O + | | | | | | |
| [symbol] | | | | | | |
| Glass | | | | | | |
| properties | | | | | | |
| Tg | ° C. | | 684 | | | |
| Keatite | ° C. | 1029 | 1027 | >1005 | >1005 | >1005 |
| solid | | | | | | |

[symbol]

indicates data missing or illegible when filed

TABLE 2
Variant A

| | | | | | | | | |
|---|---|---|---|---|---|---|---|---|
| Glass | | 2 | 2 | 2 | 3 | 3 | 3 | 4 |
| Example | | 1 | 2 | 3 | 4 | 5 | 6 | 7 |
| Comparative | | | | | | | | |
| example | | | | | | | | |
| Properties of | | | | | | | | |
| glass ceramic | | | | | | | | |
| Variant | | A | A | A | A | A | A | A |
| Embodiment | | 2 | 2 | 2 | 2 | 2 | 2 | 2 |
| Ceramization | | g21 | g21 | g21 | g21 | g21 | g21 | g21 |
| methods 1 | | | | | | | | |
| Ceramization | | g41 | g41 | g41 | | | g41 | g41 |
| methods 2 | | | | | | | | |
| T D | ° C. | 1145 | 1170 | 1145 | 1170 | 1145 | 1145 | 1170 |
| tV | min | 6.5 | 6.5 | 15 | 6.5 | 6.5 | 15 | 6.5 |
| Transmission | mm | 3.95 | 3.98 | 3.90 | 3.96 | 3.95 | 3.96 | 3.89 |
| (D65/2°), | | | | | | | | |
| Thickness | | | | | | | | |
| Y | % | 1.4 | 0.3 | 0.6 | 0.5 | 1.7 | 0.5 | 1.3 |
| (PvK-PiP)/PiP at | | 100.5 | 104.8 | 119.8 | 103.7 | 104.3 | 120.0 | 106.6 |
| 630 nm | | | | | | | | |
| Transmission at | % | 8.1 | 3.4 | 4.8 | 3.7 | 8.3 | 3.9 | 6.2 |
| 700 nm (PvK) | | | | | | | | |
| Transmission at | % | 63.6 | 40.7 | 46.0 | 44.6 | 67.5 | 46.5 | 44.9 |
| 1600 nm (PvK) | | | | | | | | |
| Reflection | mm | 3.95 | 3.98 | 3.90 | 3.96 | 3.95 | 3.96 | 3.89 |
| (D65/2°), | | | | | | | | |
| Thickness | | | | | | | | |
| L* | | 85.0 | 92.2 | 91.3 | 92.5 | 89.0 | 92.1 | 93.1 |
| a* | | 0.2 | 0.3 | 0.3 | −0.4 | 0.9 | −0.5 | −0.3 |
| b* | | −0.6 | −1.9 | −2.2 | −3.8 | −5.5 | −4.1 | −2.5 |
| c* | | 0.6 | 1.9 | 2.2 | 3.8 | 5.5 | 4.1 | 2.5 |
| α̅(20° C.; 700° C.) | ppm/K | 0.97 | | | | | | |
| Glass | | 4 | 5 | 6 | 6 | 7 | 7 | 8 |
| Example | | 8 | 9 | 10 | 11 | 12 | 13 | 14 |
| Comparative Example | | | | | | | | |
| Glass ceramic | | | | | | | | |
| properties | | | | | | | | |
| Variant | | A | A | A | A | A | A | A |
| Embodiment | | 2 | 2 | 2 | 2 | 2 | 2 | 2 |
| Ceramization methods | | g21 | g21 | g21 | g21 | g21 | g21 | g21 |
| 1 | | | | | | | | |
| Ceramization methods | | g41 | g41 | g41 | g41 | g41 | g41 | g41 |
| 2 | | | | | | | | |
| T_{D} | ° C. | 1145 | 1170 | 1170 | 1145 | 1170 | 1145 | 1170 |
| tV | min | 15 | 6.5 | 6.5 | 15 | 6.5 | 15 | 6.5 |
| Transmission | mm | 3.88 | 3.96 | 3.86 | 3.84 | 3.93 | 3.90 | 3.96 |
| (D65/2°), Thickness | | | | | | | | |
| Y | % | 0.8 | 1.6 | 1.3 | 1.8 | 1.4 | 1.9 | 1.9 |
| (PvK-PiP)/PiP at 630 | | 103.9 | 93.5 | 105.0 | 101.3 | 101.3 | 96.1 | 100.7 |
| nm | | | | | | | | |
| Transmission at 700 nm | % | 4.4 | 6.5 | 6.1 | 7.4 | 6.1 | 7.7 | 7.3 |
| (PvK) | | | | | | | | |
| Transmission at 1600 | % | 50.6 | 39.8 | 53.4 | 59.2 | 51.6 | 59.6 | 54.9 |
| nm (PvK) | | | | | | | | |
| Reflection (D65/2°), | mm | 3.88 | 3.96 | 3.86 | 3.84 | 3.93 | 3.90 | 3.96 |
| Thickness | | | | | | | | |
| L* | | 93.9 | 92.7 | 93.1 | 92.5 | 93.1 | 92.1 | 93.2 |
| a* | | −0.1 | −0.3 | −0.3 | −0.5 | −0.3 | −0.6 | −0.5 |
| b* | | −2.3 | −2.1 | −2.3 | −2.6 | −2.4 | −2.7 | −2.2 |
| c* | | 2.3 | 2.2 | 2.3 | 2.6 | 2.5 | 2.7 | 2.2 |
| α̅(20° C.; 700° C.) | ppm/K | | | | | | | |

| | | | | | | | | |
|---|---|---|---|---|---|---|---|---|
| Glass | | 9 | 9 | 10 | 10 | 11 | 11 | 12 |
| Example | | 15 | 16 | 17 | 18 | 19 | 20 | 21 |
| Comparative | | | | | | | | |
| Example | | | | | | | | |
| Glass ceramic | | | | | | | | |
| properties | | | | | | | | |
| Variant | | A | A | A | A | A | A | A |
| Embodiment | | 2 | 2 | 2 | 2 | 2 | 2 | 1 |
| Ceramization | | g21 | g21 | g21 | g21 | g21 | g21 | g11 |
| methods 1 | | | | | | | | |
| Ceramization | | g41 | g41 | g41 | g41 | g41 | g41 | g31 |
| methods 2 | | | | | | | | |
| TD | ° C. | 1170 | 1145 | 1170 | 1145 | 1170 | 1145 | 1145 |
| tV | min | 6.5 | 15 | 6.5 | 15 | 6.5 | 15 | 6.5 |
| Transmission | mm | 3.92 | 3.97 | 3.90 | 3.99 | 3.94 | 3.95 | 3.94 |
| (D65/2°), Thickness | | | | | | | | |
| Y | % | 2.0 | 1.6 | 2.0 | 1.3 | 1.6 | 1.9 | 0.6 |
| (PvK-PiP)/PiP at 630 | | 99.0 | 97.0 | 102.3 | 107.1 | 99.5 | 101.3 | 106.4 |
| nm | | | | | | | | |
| Transmission at 700 | % | 7.2 | 6.7 | 7.3 | 5.4 | 6.1 | 6.6 | 3.3 |
| nm (PvK) | | | | | | | | |
| Transmission at 1600 | % | 41.9 | 6.7 | 41.2 | 5.4 | 35.3 | 38.4 | 26.9 |
| nm (PvK) | | | | | | | | |
| Reflection (D65/2°), | mm | 3.92 | 3.97 | 3.90 | 3.99 | 3.94 | 3.95 | 3.94 |
| Thickness | | | | | | | | |
| L* | | 93.1 | 92.7 | 92.8 | 93.3 | 93.8 | 92.9 | 94.5 |
| a* | | −0.3 | −0.4 | −0.4 | −0.2 | −0.2 | −0.2 | 0.2 |
| b* | | −2.4 | −2.3 | −2.3 | −1.9 | −1.9 | −1.6 | −0.9 |
| c* | | 2.5 | 2.3 | 2.3 | 1.9 | 1.9 | 1.7 | 0.9 |
| α̅(20° C.; 700° C.) | ppm/K | 0.91 | | | | | | |
| Glass | | 12 | 12 | 13 | 13 | 14 | 14 | 14 |
| Example | | 22 | 23 | 24 | 25 | | | |
| Comparative | | | | | | 26 | 27 | 28 |
| Example | | | | | | | | |
| Glass ceramic | | | | | | | | |
| properties | | | | | | | | |
| Variant | | A | A | A | A | A | A | A |
| Embodiment | | 1 | 1 | 2 | 2 | | | |
| Ceramization | | g11 | g11 | g21 | g21 | g21 | g21 | g21 |
| methods 1 | | | | | | | | |
| Ceramization | | g31 | g31 | g41 | g41 | | g41 | g41 |
| methods 2 | | | | | | | | |
| TD | ° C. | 1170 | 1145 | 1170 | 1145 | 1145 | 1170 | 1145 |
| tV | min | 6.5 | 15 | 6.5 | 15 | 6.5 | 6.5 | 15 |
| Transmission | mm | 4.05 | 3.99 | 4.01 | 3.98 | 3.94 | 3.91 | 3.91 |
| (D65/2°), Thickness | | | | | | | | |
| Y | % | 0.2 | 0.3 | 1.1 | 1.9 | 1.5 | 0.7 | 0.8 |
| (PvK-PiP)/PiP at 630 | 202.3 | 812.0 | 109. | 893.9 | 109.3 | 114.1 | 129.6 | |
| nm | | | | | | | | |
| Transmission at 700 | % | 1.5 | 1.8 | 5.3 | 6.9 | 6.2 | 3.7 | 4.1 |
| nm (PvK) | | | | | | | | |
| Transmission at 1600 | % | 17.0 | 18.3 | 45.1 | 45.6 | 29.2 | 20.5 | 21.3 |
| nm (PvK) | | | | | | | | |
| Reflection (D65/2°), | mm | 4.05 | 3.99 | 4.01 | 3.98 | 3.94 | 3.91 | 3.91 |
| Thickness | | | | | | | | |
| L* | | 95.5 | 95.8 | 94.0 | 92.3 | 95.0 | 96.7 | 94.4 |
| a* | | −0.1 | −0.2 | −0.3 | −0.6 | −0.7 | −0.3 | −0.4 |
| b* | | 1.2 | −0.8 | −1.6 | −1.7 | −1.9 | −1.5 | −0.8 |
| c* | | 1.2 | 0.9 | 1.6 | 1.8 | 2.0 | 1.5 | 0.9 |
| α̅(20° C.; 700° C.) | ppm/K | 0.99 | | | | | | |

| | | | | | | | | |
|---|---|---|---|---|---|---|---|---|
| Glass | | 15 | 15 | 16 | 16 | 17 | 17 | 18 |
| Example | | 29 | 30 | 31 | 32 | 33 | 34 | 35 |
| Comparative | | | | | | | | |
| Example | | | | | | | | |
| Glass ceramic | | | | | | | | |
| properties | | | | | | | | |
| Variant | | A | A | A | A | A | A | A |
| Embodiment | | 2 | 2 | 2 | 2 | 2 | 2 | 2 |
| Ceramization | | g21 | g21 | g21 | g21 | g21 | g21 | g21 |
| methods 1 | | | | | | | | |
| Ceramization | | g41 | g41 | g41 | g41 | g41 | g41 | g41 |
| methods 2 | | | | | | | | |
| TD | ° C. | 1170 | 1145 | 1170 | 1145 | 1170 | 1145 | 1170 |
| tV | min | 6.5 | 15 | 6.5 | 15 | 6.5 | 15 | 6.5 |
| Transmission | mm | 4.00 | 4.00 | 4.00 | 3.99 | 3.92 | 3.91 | 3.91 |
| (D65/2°), Thickness | | | | | | | | |
| Y | % | 1.6 | 1.6 | 0.8 | 1.1 | 1.2 | 1.7 | 0.9 |
| (PvK-PiP)/PiP at 630 | | 111.6 | 99.5 | 102.1 | 102.7 | 91.7 | | 102.8 |
| nm | | | | | | | | |
| Transmission at 700 | % | 6.1 | 6.0 | 4.9 | 5.8 | 6.2 | 7.4 | 5.2 |
| nm (PvK) | | | | | | | | |
| Transmission at 1600 | % | 38.1 | 39.7 | 47.9 | 50.4 | 44.7 | 51.2 | 49.2 |
| nm (PvK) | | | | | | | | |
| Reflection (D65/2°), | mm | 4.00 | 4.00 | 4.00 | 3.99 | 3.92 | 3.91 | 3.91 |
| Thickness | | | | | | | | |
| L* | | 93.8 | 93.6 | 92.8 | 91.6 | 93.1 | 92.4 | 93.3 |
| a* | | −0.2 | −0.2 | −0.3 | −0.6 | −0.4 | −0.5 | −0.4 |
| b* | | −1.7 | −1.3 | −3.4 | −3.8 | −3.8 | −3.9 | −3.4 |
| c* | | 1.7 | 1.3 | 3.4 | 3.8 | 3.8 | 3.9 | 3.4 |
| α̅(20° C.; 700° C.) | ppm/K | | | | | | | |
| Glass | | 18 | 19 | 19 | 19 | 20 | 20 | 21 |
| Example | | 36 | 37 | 38 | 39 | 40 | 41 | 42 |
| Comparative | | | | | | | | |
| Example | | | | | | | | |
| Properties of glass | | | | | | | | |
| ceramic | | | | | | | | |
| Variant | | A | A | A | A | A | A | A |
| Embodiment | | 2 | 1 | 1 | 1 | 2 | 2 | 1 |
| Ceramization | | g21 | g11 | g11 | g11 | g21 | g21 | g11 |
| methods 1 | | | | | | | | |
| Ceramization | | g41 | g31 | g31 | g31 | g41 | g41 | g31 |
| methods 2 | | | | | | | | |
| TD | ° C. | 1145 | 1145 | 1170 | 1145 | 1170 | 1145 | 1145 |
| tV | min | 15 | 6.5 | 6.5 | 15 | 6.5 | 15 | 6.5 |
| Transmission | mm | 3.91 | 4.00 | 3.97 | 4.00 | 4.00 | 3.98 | 3.98 |
| (D65/2°), Thickness | | | | | | | | |
| Y | % | 1.3 | 1.7 | 0.6 | 0.6 | 1.3 | 1.2 | 1.4 |
| (PvK-PiP)/PiP at 630 | | | 95.1 | 100.4 | | 90.5 | | 93.9 |
| nm | | | | | | | | |
| Transmission at 700 | % | 6.7 | 7.4 | 3.9 | 3.8 | 5.8 | 5.4 | 6.0 |
| nm (PvK) | | | | | | | | |
| Transmission at 1600 | % | 56.6 | 68.9 | 50.2 | 54.4 | 61.4 | 62.4 | 64.5 |
| nm (PvK) | | | | | | | | |
| Reflection (D65/2°), | mm | 3.91 | 4.00 | 3.97 | 4.00 | 4.00 | 3.98 | 3.98 |
| Thickness | | | | | | | | |
| L* | | 92.4 | 93.3 | 94.8 | 95.5 | 95.4 | 95.5 | 94.2 |
| a* | | −0.6 | −1.1 | −0.4 | −0.4 | −0.5 | −0.5 | −0.8 |
| b* | | −3.9 | −1.1 | −0.9 | −1.2 | −1.5 | −1.8 | −1.5 |
| c* | | 3.9 | 1.5 | 1.0 | 1.3 | 1.6 | 1.9 | 1.7 |
| α̅(20° C.; 700° C.) | ppm/K | 0.62 | 0.66 | | | | | |

| | | | | | |
|---|---|---|---|---|---|
| Glass | | 21 | 21 | 22 | 22 |
| Example | | 43 | 44 | 45 | 46 |
| Comparative | | | | | |
| Example | | | | | |
| Properties of glass | | | | | |
| ceramic | | | | | |
| Variant | | A | A | A | A |
| Embodiment | | 1 | 1 | 2 | 2 |
| Ceramization | g11 | g11 | g21 | g21 | |
| methods 1 | | | | | |
| Ceramization | g31 | g31 | g41 | g41 | |
| methods 2 | | | | | |
| TD | ° C. | 1170 | 1145 | 1170 | 1145 |
| tV | min | 6.5 | 15 | 6.5 | 15 |
| Transmission | mm | 4.01 | 4.01 | 4.03 | 3.96 |
| (D65/2°) Thickness, | | | | | |
| Y | % | 0.4 | 0.6 | 0.8 | 0.6 |
| (PvK-PiP)/PiP at 630 | | 83.2 | | 115.6 | |
| nm | | | | | |
| Transmission at 700 | % | 3.0 | 3.3 | 4.5 | 3.6 |
| nm (PvK) | | | | | |
| Transmission at 1600 | % | 43.9 | 47.2 | 35.1 | 29.5 |
| nm (PvK) | | | | | |
| Reflection (D65/2°), | mm | 4.01 | 4.01 | 4.03 | 3.96 |
| Thickness | | | | | |
| L* | | 95.9 | 95.9 | 93.5 | 94.4 |
| a* | | −0.3 | −0.3 | −0.2 | −0.1 |
| b* | | −1.2 | −1.3 | −1.9 | −1.6 |
| c* | | 1.3 | 1.3 | 2.0 | 1.6 |
| α̅(20° C.; 700° C.) | ppm/K | | | | |
| Glass | | 23 | 25 | 27 | 28 |
| Example | | 47 | 48 | 49 | 50 |
| Comparative | | | | | |
| Example | | | | | |
| Properties of glass | | | | | |
| ceramic | | | | | |
| Variant | | A | A | A | A |
| Embodiment | | 2 | 2 | 1 | 2 |
| Ceramization | | g21 | g21 | g11 | g21 |
| methods 1 | | | | | |
| Ceramization | | g41 | g41 | | |
| methods 2 | | | | | |
| T_{D} | ° C. | 1145 | 1145 | 1145 | 1145 |
| t_{V} | min | 15 | 15 | 6.5 | 6.5 |
| Transmission | mm | 3.96 | 3.94 | 3.98 | 3.98 |
| (D65/2°), Thickness | | | | | |
| Y | % | 1.9 | 0.8 | 1.6 | 2.0 |
| Transmission @ 630 | % | 4.3 | 2.4 | 4.0 | 5.1 |
| nm (PvK) | | | | | |
| Transmission @ 630 | % | | | | |
| nm (PiP) | | | | | |
| PvK-PiP @ 630 nm | % | | | | |
| (PvK-PiP)/PiP @ 630 | | | | | |
| nm | | | | | |
| Transmission @ 700 | % | 7.1 | 4.9 | 7.3 | 8.7 |
| nm (PvK) | | | | | |
| Transmission @ 1600 | % | 41.8 | 52.2 | 67.2 | 55.9 |
| nm (PvK) | | | | | |
| Reflection (D65/2°), | mm | 3.96 | 3.94 | 3.98 | 3.98 |
| Thickness | | | | | |
| L* | | 91.0 | 91.6 | 92.2 | 89.5 |
| a* | | −0.3 | −0.3 | −0.7 | −0.7 |
| b* | | −0.4 | −1.7 | −0.2 | −1.1 |
| c* | | 0.5 | 1.7 | 0.7 | 1.3 |
| α̅(20° C.; 700° C.) | ppm/K | | | 0.68 | |

| | | | | | | |
|---|---|---|---|---|---|---|
| Glass | | 29 | 30 | 31 | 33 | 34 |
| Example | | 51 | 52 | 53 | 54 | 55 |
| Comparative Example | | | | | | |
| Properties of glass | | | | | | |
| ceramic | | | | | | |
| Variant | | A | A | A | A | A |
| Embodiment | | 2 | 2 | 1 | 2 | 2 |
| Ceramization | | g21 | g21 | g11 | g21 | g21 |
| methods 1 | | | | | | |
| Ceramization | | g41 | g41 | g41 | | |
| methods 2 | | | | | | |
| T_{D} | ° C. | 1145 | 1145 | 1145 | 1145 | 1145 |
| t_{V} | min | 6.5 | 15 | 6.5 | 15 | 15 |
| Transmission(D65/2), | mm | 3.98 | 3.96 | 3.96 | 3.94 | 3.92 |
| Thickness | | | | | | |
| Y | % | 1.7 | 1.5 | 1.8 | 0.5 | 0.4 |
| Transmission @ 630 | % | 4.2 | 3.7 | 4.7 | 1.6 | 1.4 |
| nm (PvK) | | | | | | |
| Transmission @ 630 | % | | | | | |
| nm (PiP) | | | | | | |
| PvK-PiP @ 630 nm | % | | | | | |
| (PvK-PiP)/PiP @ 630 | | | | | | |
| nm | | | | | | |
| Transmission @ 700 | % | 7.7 | 6.2 | 8.2 | 3.5 | 3.2 |
| nm (PvK) | | | | | | |
| Transmission @ 160 | % | 53.3 | 40.4 | 66.7 | 48.0 | 45.3 |
| nm (PvK) | | | | | | |
| Reflection (D65/2°), | mm | 3.98 | 3.96 | 3.96 | 3.94 | 3.92 |
| Thickness | | | | | | |
| L* | | 90.2 | 92.3 | 91.5 | 92.1 | 92.6 |
| a* | | −0.4 | −0.1 | −0.8 | −0.2 | −0.3 |
| b* | | −0.4 | −0.4 | −1.1 | −1.5 | −1.0 |
| c* | | 0.5 | 0.4 | 1.4 | 1.5 | 1.1 |
| α̅(20° C.; 700° C.) | | | | | 0.90 | 0.91 |
| ppm/K | | | | | | |

| | | | | | | | |
|---|---|---|---|---|---|---|---|
| Glass | | 35 | 36 | 37 | 38 | 39 | 40 |
| Example | | 56 | 57 | 58 | 59 | 60 | 61 |
| Comparative Example | | | | | | | |
| Properties of glass | | | | | | | |
| ceramic | | | | | | | |
| Variant | | A | A | A | A | A | A |
| Embodiment | | 2 | 2 | 2 | 2 | 2 | 2 |
| Ceramization | | g21 | g21 | g21 | g21 | g21 | g21 |
| methods 1 | | | | | | | |
| Ceramization | | g41 | g41 | g41 | g41 | g41 | g41 |
| methods 2 | | | | | | | |
| T_{D} | ° C. | 1145 | 1145 | 1145 | 1145 | 1145 | 1145 |
| t_{V} | min | 15 | 15 | 15 | 15 | 15 | 15 |
| Transmission(D65/2°), | mm | 3.93 | 4.05 | 3.86 | 3.97 | 3.89 | 3.98 |
| Thickness | | | | | | | |
| Y | % | 0.3 | 0.3 | 1.0 | 0.8 | 1.8 | 1.3 |
| Transmission @ 630 | % | 1.1 | 1.1 | 2.9 | 2.5 | 4.5 | 3.6 |
| nm (PvK) | | | | | | | |
| Transmission @ 630 | % | | | | | | |
| nm (PiP) | | | | | | | |
| PvK-PiP @ 630 nm | % | | | | | | |
| (PvK-PiP)/PiP @ 630 | | | | | | | |
| nm | | | | | | | |
| Transmission @ 700 | % | 2.7 | 2.7 | 5.7 | 5.1 | 7.7 | 6.5 |
| nm (PvK) | | | | | | | |
| Transmission @ 1600 | % | 52.3 | 44.9 | 54.0 | 52.8 | 55.8 | 52.8 |
| nm (PvK) | | | | | | | |
| Reflection (D65/2°), | mm | 3.93 | 4.05 | 3.86 | 3.97 | 3.89 | 3.98 |
| Thickness | | | | | | | |
| L* | | 90.5 | 92.7 | 90.8 | 90.7 | 91.1 | 91.3 |
| a* | | −0.3 | −0.3 | −0.5 | −0.5 | −0.5 | −0.6 |
| b* | | −2.8 | −1.5 | −2.4 | −2.1 | −1.4 | −1.1 |
| c* | | 2.8 | 1.6 | 2.4 | 2.2 | 1.5 | 1.3 |
| | ppm/K | 0.82 | 0.87 | 0.93 | 0.93 | 0.92 | 0.91 |
| Glass | | 41 | 42 | 44 | 45 | 46 | 47 |
| Example | | 62 | 63 | 64 | 65 | 66 | 67 |
| Comparative | | | | | | | |
| Example | | | | | | | |
| Properties of glass | | | | | | | |
| ceramic | | | | | | | |
| Variant | | A | A | A | A | A | A |
| Embodiment | | 2 | 2 | 2 | 2 | 2 | 2 |
| Ceramization | | g21 | g21 | g21 | g21 | g21 | g21 |
| methods 1 | | | | | | | |
| Ceramization | | g41 | g41 | g41 | g41 | g41 | g41 |
| methods 2 | | | | | | | |
| T_{D} | ° C. | 1145 | 1145 | 1145 | 1145 | 1145 | 1145 |
| t_{V} | min | 15 | 15 | 15 | 15 | 15 | 15 |
| Transmission | mm | 3.97 | 3.97 | 3.94 | 3.85 | 3.86 | 4.10 |
| (D65/2°), Thickness | | | | | | | |
| Y | % | 1.6 | 1.2 | 1.8 | 2.0 | 1.7 | 0.3 |
| Transmission @ 630 | % | 4.3 | 3.6 | 4.5 | 5.1 | 4.7 | 1.1 |
| nm (PvK) | | | | | | | |
| Transmission @ 630 | % | | | | | | |
| nm (PiP) | | | | | | | |
| PvK-PiP @ 630 nm | % | | | | | | |
| (PvK-PiP)/PiP @ 630 | | | | | | | |
| nm | | | | | | | |
| Transmission @ 700 | % | 7.5 | 6.5 | 7.6 | 8.3 | 7.9 | 2.6 |
| nm (PvK) | | | | | | | |
| Transmission @ 1600 | % | 55.3 | 52.6 | 49.2 | 52.9 | 53.7 | 45.6 |
| nm (PvK) | | | | | | | |
| Reflection (D65/2°), | mm | 3.97 | 3.97 | 3.94 | 3.85 | 3.86 | 4.10 |
| Thickness | | | | | | | |
| L* | | 90.8 | 90.7 | 91.5 | 90.7 | 90.8 | 92.1 |
| a* | | −0.5 | −0.6 | −0.6 | −0.5 | −0.6 | −0.4 |
| b* | | −2.3 | −1.7 | −0.9 | −2.4 | −2.0 | −2.4 |
| c* | | 2.3 | 1.8 | 1.0 | 2.4 | 2.1 | 2.4 |
| α̅(20° C.; 700° C.) | ppm/K | 0.93 | 0.91 | 1.01 | 1.02 | 1.00 | 0.91 |

PVK = specimen in front of the sphere; PiP = specimen in the specimen chamber - Translator's note

TABLE 3
Variant B

| Glass | 1 | | 2 | 4 | 5 | 6 | 7 |
|---|---|---|---|---|---|---|---|
| Example | | 68 | 69 | 70 | 71 | 72 | 73 |
| Comparative | | | | | | | |
| Example | | | | | | | |
| Properties of glass | | | | | | | |
| ceramic | | | | | | | |
| Variant | | B | B | B | B | B | B |
| Embodiment | | 2 | 2 | 2 | 2 | 2 | 2 |
| Ceramization | | g22 | g22 | g22 | g22 | g22 | g22 |
| methods 1 | | | | | | | |
| Ceramization | | g42 | | g42 | g42 | g42 | g42 |
| methods 2 | | | | | | | |
| T_{D} | ° C. | 1145 | 1100 | 1145 | 1145 | 1145 | 1145 |
| t_{V} | min | 6.5 | 6.5 | 6.5 | 6.5 | 6.5 | |
| Transmission | mm | 3.98 | 4.01 | 3.92 | 3.97 | 3.96 | 3.92 |
| (D65/2°), Thickness | | | | | | | |
| Y | % | 2.3 | 8.2 | 4.0 | 4.7 | 3.3 | 3.2 |
| Transmission at | % | 5.2 | 16.2 | 7.9 | 8.6 | 6.9 | 7.4 |
| 630 nm (PvK) | | | | | | | |
| Transmission at | % | 0.1 | 3.1 | 0.1 | 0.1 | 0.1 | 0.1 |
| 630 nm (PiP) | | | | | | | |
| (PvK-PiP)/PiP | 103.6 | 4.2 | 99.3 | 94.3 | 99.0 | 96.2 | |
| at 630 nm | | | | | | | |
| Transmission at | % | 9.1 | 26.2 | 11.9 | 12.1 | 10.9 | 11.3 |
| 700 nm (PvK) | | | | | | | |
| Transmission at | % | 68.5 | 77.8 | 65.5 | 60.5 | 72.2 | 71.1 |
| 1600 nm (PvK) | | | | | | | |
| Display capability | | | poor | | | | |
| for red | | | | | | | |
| Reflection (D65/2°), | mm | 3.98 | 4.01 | 3.92 | 3.97 | 3.96 | 3.92 |
| Thickness | | | | | | | |
| L* | | 87.5 | 72.3 | 89.0 | 85.4 | 89.7 | 89.6 |
| a* | | −0.8 | −2.0 | −1.1 | −1.4 | −1.1 | −1.0 |
| b* | | −0.8 | −6.3 | −4.1 | −1.3 | −3.9 | −3.6 |
| c* | | 1.1 | 6.6 | 4.3 | 1.9 | 4.0 | 3.8 |
| α̅(20° C.; 700° C.) | ppm/K | | 0.96 | | 0.95 | | |
| Glass | | 8 | 8 | 9 | 10 | 11 | 12 |
| Example | | 74 | 75 | 76 | 77 | 78 | 79 |
| Comparative Example | | | | | | | |
| Properties of glass | | | | | | | |
| ceramic | | | | | | | |
| Variant | | B | B | B | B | B | B |
| Embodiment | | 2 | 2 | 2 | 2 | 2 | 1 |
| Ceramization | | g22 | g22 | g22 | g22 | g22 | g12 |
| methods 1 | | | | | | | |
| Ceramization | | g42 | g42 | g42 | g42 | g42 | g32 |
| methods 2 | | | | | | | |
| T_{D} | ° C. | 1145 | 1145 | 1145 | 1145 | 1145 | 1100 |
| t_{V} | min | 6.5 | 15 | 6.5 | 6.5 | 6.5 | 6.5 |
| Transmission | mm | 3.90 | 3.93 | 3.93 | 3.99 | 3.96 | 4.00 |
| (D65/2°), Thickness | | | | | | | |
| Y | % | 5.2 | 3.0 | 5.7 | 5.1 | 4.5 | 4.6 |
| Transmission at | % | 9.5 | 6.1 | 9.8 | 9.0 | 8.1 | 8.4 |
| 630 nm (PvK) | | | | | | | |
| Transmission at | % | 0.1 | 0.1 | 0.1 | 0.1 | 0.1 | 0.1 |
| 630 nm (PiP) | | | | | | | |
| (PvK-PiP)/PiP at | | 91.8 | 105.6 | 94.3 | 91.0 | 94.5 | 96.3 |
| 630 nm | | | | | | | |
| Transmission at | % | 13.5 | 9.4 | 13.4 | 12.5 | 11.4 | 11.9 |
| 700 nm (PvK) | | | | | | | |
| Transmission at | % | 73.5 | 60.1 | 62.1 | 61.8 | 54.5 | 60.7 |
| 1600 nm (PvK) | | | | | | | |
| Display capability | | | poor | | | | |
| for red | | | | | | | |
| Reflection (D65/2°), | mm | 3.90 | 3.93 | 3.93 | 3.99 | 3.96 | 4.00 |
| Thickness | | | | | | | |
| L* | | 89.1 | 92.3 | 88.7 | 88.4 | 89.7 | 85.4 |
| a* | | −1.4 | −0.8 | −1.4 | −1.2 | −0.9 | −1.1 |
| b* | | −3.8 | −2.6 | −4.2 | −3.7 | −2.9 | −1.3 |
| c* | | 4.1 | 2.8 | 4.5 | 3.9 | 3.0 | 1.7 |
| α̅(20° C.; 700° C.) | ppm/K | | | | | | 0.85 |
| Glass | | 12 | 12 | 12 | 13 | 13 | 14 |
| Example | | 80 | 81 | 82 | 83 | 84 | |
| Comparative Example | | | | | | | |
| Properties of glass | | | | | | | 85 |
| ceramic | | | | | | | |
| Variant | | B | B | B | B | B | B |
| Embodiment | | 1 | 1 | 1 | 2 | 2 | |
| Ceramization | | g12 | g12 | g12 | g22 | g22 | g22 |
| methods 1 | | | | | | | |
| Ceramization | | g32 | | | g42 | g42 | |
| methods 2 | | | | | | | |
| T_{D} | ° C. | 1120 | 1080 | 1065 | 1145 | 1120 | 1100 |
| t_{V} | min | 6.5 | 6.5 | 15 | 6.5 | 6.5 | 6.5 |
| Transmission | mm | 3.99 | 3.95 | 3.93 | 4.00 | 3.98 | 3.92 |
| (D65/2°), Thickness | | | | | | | |
| Y | % | 2.2 | 8.6 | 8.5 | 3.1 | 7.4 | 5.9 |
| Transmission at | % | 4.6 | 13.2 | 13.1 | 6.5 | 12.5 | 10.9 |
| 630 nm (PvK) | | | | | | | |
| Transmission at | % | 0.2 | 0.2 | 0.1 | 0.3 | 0.1 | |
| 630 nm (PiP) | | | | | | | |
| (PvK-PiP)/PiP at | | | 68.3 | 65.3 | 105.4 | 39.7 | 97.6 |
| 630 nm | | | | | | | |
| Transmission at | % | 7.3 | 16.8 | 16.7 | 10.1 | 17.3 | 14.2 |
| 700 nm (PvK) | | | | | | | |
| Transmission at | % | 45.7 | 69.0 | 69.1 | 64.4 | 76.9 | 58.5 |
| 1600 nm (PvK) | | | | | | | |
| Display capability | | | none | none | | none | |
| for red | | | | | | | |
| Reflection (D65/2°), | mm | 3.99 | 3.95 | 3.93 | 4.00 | 3.98 | 3.92 |
| Thickness | | | | | | | |
| L* | | 91.5 | 82.4 | 82.0 | 90.4 | 83.2 | 89.1 |
| a* | | −0.6 | −2.6 | −2.6 | −1.0 | −2.6 | −2.3 |
| b* | | −1.0 | −3.3 | −3.2 | −2.4 | −5.2 | −4.1 |
| c* | | 1.2 | 4.2 | 4.1 | 2.6 | 5.8 | 4.7 |
| α̅(20° C.; 700° C.) | ppm/K | | | | 0.84 | | 0.97 |
| Glass | | 14 | 15 | 15 | 16 | 17 | 18 |
| Example | | 87 | 88 | 89 | 90 | 91 | |
| Comparative | | 86 | | | | | |
| Example | | | | | | | |
| Properties of glass | | | | | | | |
| ceramic | | | | | | | |
| Variant | | B | B | B | B | B | B |
| Embodiment | | | 2 | 2 | 2 | 2 | 2 |
| Ceramization | | g22 | g22 | g22 | g22 | g22 | g22 |
| methods 1 | | | | | | | |
| Ceramization | | g42 | g42 | g42 | g42 | g42 | g42 |
| methods 2 | | | | | | | |
| T_{D} | ° C. | 1120 | 1145 | 1120 | 1145 | 1145 | 1145 |
| t_{V} | min | 6.5 | 6.5 | 6.5 | 6.5 | 6.5 | 6.5 |
| Transmission | mm | 3.92 | 3.99 | 3.99 | 3.99 | 3.91 | 3.92 |
| (D65/2°), Thickness | | | | | | | |
| Y | % | 3.3 | 3.9 | 8.0 | 2.6 | 3.7 | 2.7 |
| Transmission at | % | 7.3 | 7.3 | 12.5 | 6.3 | 8.0 | 6.5 |
| 630 nm (PvK) | | | | | | | |
| Transmission at | % | | 0.1 | 0.2 | 0.1 | | |
| 630 nm (PiP) | | | | | | | |
| (PvK-PiP)/PiP at | 96.9 | 78.9 | 99.3 | | | | |
| 630 nm | | | | | | | |
| Transmission at | % | 10.2 | 10.8 | 16.1 | 10.3 | 11.7 | 10.4 |
| 700 nm (PvK) | | | | | | | |
| Transmission at | % | 44.5 | 58.6 | 72.2 | 70.9 | 66.0 | 71.1 |
| 1600 nm (PvK) | | | | | | | |
| Display capability | | | | none | | | |
| for red | | | | | | | |
| Reflection (D65/2°), | mm | 3.92 | 3.99 | 3.99 | 3.99 | 3.91 | 3.92 |
| Thickness | | | | | | | |
| L* | | 92.4 | 90.4 | 84.6 | 89.3 | 89.7 | 90.0 |
| a* | | −1.4 | −0.8 | −1.9 | −1.0 | −1.2 | −1.1 |
| b* | −2.8 | −2.9 | −4.4 | −5.3 | −5.5 | −5.2 | |
| c* | | 3.1 | 3.0 | 4.8 | 5.4 | 5.6 | 5.3 |
| α̅(20° C.; 700° C.) | ppm/K | | 0.79 | | | | |
| Glass | | 19 | 19 | 20 | 20 | 21 | 21 |
| Example | | 92 | 93 | 94 | 95 | 96 | 97 |
| Comparative Example | | | | | | | |
| Properties of glass | | | | | | | |
| ceramic | | | | | | | |
| Variant | | B | B | B | B | B | B |
| Embodiment | | 1 | 1 | 2 | 2 | 1 | 1 |
| Ceramization | | g12 | g12 | g22 | g22 | g12 | g12 |
| methods 1 | | | | | | | |
| Ceramization | | g32 | g32 | g42 | g42 | g32 | g32 |
| methods 2 | | | | | | | |
| T_{D} | ° C. | 1100 | 1120 | 1145 | 1120 | 1100 | 1120 |
| t_{V} | min | 6.5 | 6.5 | 6.5 | 6.5 | 6.5 | 6.5 |
| Transmission | mm | 4.00 | 3.98 | 4.00 | 3.96 | 4.02 | 3.99 |
| (D65/2°), Thickness | | | | | | | |
| Y | % | 9.4 | 4.9 | 3.7 | 7.4 | 7.3 | 3.7 |
| Transmission at | % | 15.6 | 9.5 | 7.3 | 12.5 | 12.6 | 7.6 |
| 630 nm (PvK) | | | | | | | |
| Transmission at | % | 1.4 | | 0.1 | 0.2 | 0.3 | |
| 630 nm (PiP) | | | | | | | |
| (PvK-PiP)/PiP at | 9.9 | 89.6 | 56.9 | 40.9 | | | |
| 630 nm | | | | | | | |
| Transmission at | % | 22.7 | 14.0 | 11.2 | 17.3 | 17.9 | 11.6 |
| 700 nm (PvK) | | | | | | | |
| Transmission at | % | 83.8 | 80.2 | 76.0 | 81.9 | 84.0 | 79.0 |
| 1600 nm (PvK) | | | | | | | |
| Display capability for | | poor | | | none | none | |
| red | | | | | | | |
| Reflection (D65/2°), | mm | 4.00 | 3.98 | 4.00 | 3.96 | 4.02 | 3.99 |
| Thickness | | | | | | | |
| L* | | 83.3 | 89.0 | 92.3 | 88.0 | 86.1 | 90.9 |
| a* | | −5.0 | −2.8 | −1.4 | −3.0 | −4.0 | −1.9 |
| b* | | −5.1 | −2.1 | −3.0 | −5.6 | −4.8 | −2.0 |
| c* | | 7.1 | 3.5 | 3.3 | 6.4 | 6.3 | 2.8 |
| α̅(20° C.; 700° C.) | ppm/K | 0.62 | | 0.76 | | 0.66 | |
| Glass | | 22 | 22 | 22 | | | |
| Example | | 98 | 99 | 100 | | | |
| Comparative | | | | | | | |
| Example | | | | | | | |
| Properties of glass | | | | | | | |
| ceramic | | | | | | | |
| Variant | | B | B | B | | | |
| Embodiment | 2 | | 2 | 2 | | | |
| Ceramization | | g22 | g22 | g22 | | | |
| methods 1 | | | | | | | |
| Ceramization | | g42 | | g42 | | | |
| methods 2 | | | | | | | |
| T_{D} | ° C. | 1145 | 1100 | 1120 | | | |
| t_{V} | min | 6.5 | 6.5 | 6.5 | | | |
| Transmission | mm | 3.98 | 4.00 | 3.99 | | | |
| (D65/2°), Thickness | | | | | | | |
| Y | % | 2.3 | 9.1 | 5.3 | | | |
| Transmission at | % | 5.1 | 14.0 | 9.5 | | | |
| 630 nm (PvK) | | | | | | | |
| Transmission at | % | 0.1 | 0.3 | | | | |
| 630 nm (PiP) | | | | | | | |
| (PvK-PiP)/PiP at | | 95.0 | 45.8 | | | | |
| 630 nm | | | | | | | |
| Transmission at | % | 8.4 | 18.2 | 13.3 | | | |
| 700 nm (PvK) | | | | | | | |
| Transmission at | % | 49.9 | 74.4 | 65.4 | | | |
| 1600 nm (PvK) | | | | | | | |
| Display capability | | | none | | | | |
| for red | | | | | | | |
| Reflection (D65/2°), | mm | 3.98 | 4.00 | 3.99 | | | |
| Thickness | | | | | | | |
| L* | | 90.6 | 81.1 | 86.7 | | | |
| a* | | −0.5 | −2.5 | −1.5 | | | |
| b* | | −2.3 | −4.8 | −3.2 | | | |
| c* | | 2.3 | 5.4 | 3.5 | | | |
| α̅(20° C.; 700° C.) | ppm/K | 0.87 | 0.86 | | | | |
| Glass | | 24 | 43 | | | | |
| Example | | 101 | 102 | | | | |
| Comparative | | | | | | | |
| Example | | | | | | | |
| Properties of | | | | | | | |
| glass ceramic | | | | | | | |
| Variant | | B | B | | | | |
| Embodiment | | 2 | 2 | | | | |
| Ceramization | | g22 | g22 | | | | |
| methods 1 | | | | | | | |
| Ceramization | | g42 | g42 | | | | |
| methods 2 | | | | | | | |
| T_{D} | ° C. | 1145 | 1145 | | | | |
| t_{V} | min | 6.5 | 15 | | | | |
| Transmission | mm | 3.95 | 3.97 | | | | |
| (D65/2°), | | | | | | | |
| Thickness | | | | | | | |
| Y | % | 2.5 | 2.1 | | | | |
| Transmission @ | % | 5.3 | 5.0 | | | | |
| 630 nm (PvK) | | | | | | | |
| Transmission @ | % | | | | | | |
| 630 nm (PiP) | | | | | | | |
| PvK-PiP @ | % | | | | | | |
| 630 nm | | | | | | | |
| (PvK-PiP)/PiP @ | | | | | | | |
| 630 nm | | | | | | | |
| Transmission @ | % | 8.2 | 8.2 | | | | |
| 700 nm (PvK) | | | | | | | |
| Transmission @ | % | 46.5 | 50.8 | | | | |
| 1600 nm (PvK) | | | | | | | |
| Display | | none | none | | | | |
| capability for red | | | | | | | |
| Reflection | mm | 3.95 | 3.97 | | | | |
| (D65/2°), | | | | | | | |
| Thickness | | | | | | | |
| L* | | 90.6 | 91.1 | | | | |
| a* | | −0.3 | −0.5 | | | | |
| b* | | −0.5 | −1.6 | | | | |
| c* | | 0.6 | 1.6 | | | | |
| α̅(20° C.; 700° C.) | ppm/K | | 1.01 | | | | |

TABLE 4
Variant C

| Glass | | 1 | 3 | 4 | 5 | 6 | 7 |
|---|---|---|---|---|---|---|---|
| Example | | 103 | 104 | 105 | 106 | 107 | 108 |
| Comparative | | | | | | | |
| Example | | | | | | | |
| Properties of glass | | | | | | | |
| ceramic | | | | | | | |
| Variant | | C | C | C | C | C | C |
| Embodiment | | 2 | 2 | 2 | 2 | 2 | 2 |
| Ceramization | | g23 | g23 | g23 | g23 | g23 | g23 |
| methods 1 | | | | | | | |
| Ceramization | | g43 | g43 | g43 | g43 | g43 | g43 |
| methods 2 | | | | | | | |
| T_{D} | ° C. | 1100 | 1100 | 1100 | 1100 | 1100 | 1100 |
| t_{V} | min | 6.5 | 6.5 | 6.5 | 6.5 | 6.5 | 6.5 |
| Transmission | mm | 3.92 | 3.91 | 4.02 | 4.01 | 3.97 | 3.95 |
| (D65/2°), Thickness | | | | | | | |
| Y | % | 11.5 | 11.6 | 14.7 | 14.1 | 12.5 | 13.3 |
| Transmission at 630 | % | 19.3 | 20.2 | 22.3 | 20.1 | 20.8 | 21.6 |
| nm (PvK) | | | | | | | |
| Transmission at 630 | % | 4.4 | 5.4 | 6.5 | 3.6 | 4.8 | 5.7 |
| nm (PiP) | | | | | | | |
| (PvK-PiP)/PiP at 630 | | 3.3 | 2.8 | 2.4 | 4.6 | 3.4 | 2.8 |
| nm | | | | | | | |
| Transmission at 700 | % | 29.1 | 30.3 | 30.8 | 26.6 | 31.3 | 31.8 |
| nm (PvK) | | | | | | | |
| Transmission at 1600 | % | 84.6 | 84.5 | 81.6 | 80.7 | 83.8 | 84.0 |
| nm (PvK) | | | | | | | |
| Display capability for | | good | good | very | poor | good | very |
| red | | | | good | | | good |
| Reflection (D65/2°), | mm | 3.92 | 3.91 | 4.02 | 4.01 | 3.97 | 3.95 |
| Thickness | | | | | | | |
| L* | | 74.3 | 71.9 | 69.6 | 71.5 | 73.6 | 72.9 |
| a* | | −4.0 | −4.0 | −3.4 | −3.1 | −4.2 | −4.1 |
| b* | | −8.1 | −10.2 | −8.3 | −5.4 | −8.3 | −8.4 |
| c* | | 9.0 | 10.9 | 9.0 | 6.3 | 9.3 | 9.3 |
| α̅(20° C.; 700° C.) | ppm/K | 1 | 0.99 | 0.89 | 0.92 | 0.9 | 0.86 |
| Glass | | 8 | 9 | 10 | 11 | 12 | 12 |
| Example | | 109 | 110 | 111 | 112 | 113 | 114 |
| Comparative Example | | | | | | | |
| Properties of glass | | | | | | | |
| ceramic | | | | | | | |
| Variant | | C | C | C | C | C | C |
| Embodiment | | 2 | 2 | 2 | 2 | 1 | 1 |
| Ceramization | | g23 | g23 | g23 | g23 | g13 | g13 |
| methods | | | | | | | |
| Ceramization | | g43 | g43 | g43 | g43 | | |
| methods 2 | | | | | | | |
| T_{D} | ° C. | 1100 | 1100 | 1100 | 1100 | 1035 | 1055 |
| t_{V} | min | 6.5 | 6.5 | 6.5 | 6.5 | 13 | 13 |
| Transmission(D65/2°), | mm | 3.97 | 3.89 | 3.94 | 3.97 | 3.95 | 3.9 |
| Thickness | | | | | | | |
| Y | % | 15.4 | 15.2 | 14.5 | 13.5 | 22.3 | 16.7 |
| Transmission at 630 | % | 23.8 | 21.7 | 20.5 | 18.6 | 29.2 | 22.5 |
| nm (PvK) | | | | | | | |
| Transmission at 630 | % | 7.9 | 4.2 | 3.5 | 2.1 | 8.5 | 3.7 |
| nm (PiP) | | | | | | | |
| (PvK-PiP)/PiP at 630 | | 2.0 | 4.2 | 4.8 | 8.1 | 2.4 | 5.1 |
| nm | | | | | | | |
| Transmission at 700 | % | 33.9 | 28.7 | 27.0 | 23.8 | 35.9 | 28.4 |
| nm (PvK) | | | | | | | |
| Transmission at 1600 | % | 84.0 | 80.9 | 80.9 | 79.0 | 78.7 | 76.4 |
| nm (PvK) | | | | | | | |
| Display capability for | | very | good | poor | poor | very | good |
| red | | good | | | | good | |
| Reflection (D65/2°), | mm | 3.97 | 3.89 | 3.94 | 3.97 | 3.95 | 3.9 |
| Thickness | | | | | | | |
| L* | | 72.0 | 72.4 | 72.5 | 74.1 | 62.7 | 68.5 |
| a* | | −4.3 | −3.5 | −3.2 | −2.7 | −3.1 | −3.1 |
| b* | | −8.4 | −8.0 | −6.3 | −5.3 | −7.1 | −5.9 |
| c* | | 9.5 | 8.7 | 7.1 | 5.9 | 7.8 | 6.6 |
| α̅(20° C.; 700° C.) | ppm/K | 0.9 | 0.99 | 0.87 | 0.87 | | |
| Glass | | 12 | 13 | 13 | 14 | 14 | 15 |
| Example | | 115 | 116 | 117 | | | 120 |
| Comparative Example | | | | | 118 | 119 | |
| Properties of glass | | | | | | | |
| ceramic | | | | | | | |
| Variant | | C | C | C | C | C | C |
| Embodiment | | 1 | 2 | 2 | 2 | | |
| Ceramization | | g13 | g23 | g23 | g23 | g23 | g23 |
| methods 1 | | | | | | | |
| Ceramization | | | g43 | | | | g43 |
| methods 2 | | | | | | | |
| T_{D} | ° C. | 1065 | 1100 | 1080 | 1035 | 1055 | 1100 |
| t_{V} | min | 6.5 | 6.5 | 6.5 | 13 | 13 | 6.5 |
| Transmission(D65/2°), | mm | 3.90 | 3.97 | 3.92 | 3.91 | 3.91 | 4.01 |
| Thickness | | | | | | | |
| Y | % | 12.5 | 12.0 | 19.0 | 21.2 | 15.7 | 12.6 |
| Transmission at 630 | % | 17.5 | 18.7 | 29.2 | 29.7 | 22.0 | 17.7 |
| nm (PvK) | | | | | | | |
| Transmission at 630 | % | 1.0 | 3.0 | 12.5 | 9.3 | 2.7 | 1.7 |
| nm (PiP) | | | | | | | |
| (PvK-PiP)/PiP at 630 | | 17.3 | 5.3 | 1.3 | 2.2 | 7.3 | 9.7 |
| nm | | | | | | | |
| Transmission at 700 | % | 22.0 | 26.3 | 40.0 | 37.5 | 27.3 | 22.6 |
| nm (PvK) | | | | | | | |
| Transmission at 1600 | % | 73.6 | 82.2 | 84.3 | 81.9 | 78.7 | 79.3 |
| nm (PvK) | | | | | | | |
| Display capability for | | poor | poor | very | very | poor | poor |
| red | | | | good | good | | |
| Reflection (D65/2°), | mm | 3.90 | 3.97 | 3.92 | 3.91 | 3.91 | 4.01 |
| Thickness | | | | | | | |
| L* | | 76.4 | 77.4 | 70.1 | 69.8 | 76.3 | 78.0 |
| a* | | −3.1 | −3.9 | −4.4 | −4.0 | −3.8 | −2.8 |
| b* | | −5.1 | −8.3 | −11.9 | −14.0 | −11.4 | −7.3 |
| c* | | 6.0 | 9.2 | 12.7 | 14.6 | 12.0 | 7.8 |
| α̅(20° C.; 700° C.) | ppm/K | | 0.82 | | | | 0.78 |
| Glass | | 15 | 15 | 16 | 17 | 18 | 19 |
| Example | | 121 | 122 | 123 | 124 | 125 | 126 |
| Comparative Example | | | | | | | |
| Properties of glass | | | | | | | |
| ceramic | | | | | | | |
| Variant | | C | C | C | C | C | C |
| Embodiment | | 2 | 2 | 2 | 2 | 2 | 1 |
| Ceramization | | g23 | g23 | g23 | g23 | g23 | g13 |
| methods 1 | | | | | | | |
| Ceramization | | | | g43 | g43 | g43 | g33 |
| methods 2 | | | | | | | |
| T_{D} | ° C. | 1080 | 1065 | 1100 | 1100 | 1100 | 1080 |
| t_{V} | min | 6.5 | 15 | 6.5 | 6.5 | 6.5 | 6.5 |
| Transmission(D65/2°), | mm | 3.97 | 3.93 | 4.00 | 3.93 | 3.94 | 3.97 |
| Thickness | | | | | | | |
| Y | % | 18.6 | 19.1 | 11.3 | 15.1 | 12.4 | 18.5 |
| Transmission at 630 | % | 26.1 | 27.0 | 19.9 | 23.4 | 21.2 | 30.3 |
| nm (PvK) | | | | | | | |
| Transmission at 630 | % | 9.9 | 10.5 | 4.0 | 7.2 | 5.5 | 14.4 |
| nm (PiP) | | | | | | | |
| (PvK-PiP)/PiP at 630 | | 1.6 | 1.6 | 4.0 | 2.2 | 2.8 | 1.1 |
| nm | | | | | | | |
| Transmission at 700 | % | 34.2 | 35.4 | 30.2 | 32.0 | 31.4 | 43.0 |
| nm (PvK) | | | | | | | |
| Transmission at 1600 | % | 83.4 | 83.2 | 83.5 | 82.7 | 84.3 | 86.0 |
| nm (PvK) | | | | | | | |
| Display capability for | | very | very | good | very | good | very |
| red | | good | good | | good | | good |
| Reflection (D65/2°), | mm | 3.97 | 3.93 | 4.00 | 3.93 | 3.94 | 3.97 |
| Thickness | | | | | | | |
| L* | | 70.2 | 69.7 | 76.6 | 73.7 | 76.3 | 72.6 |
| a* | | −3.3 | −3.3 | −3.9 | −3.7 | −4.1 | −7.3 |
| b* | | −10.1 | −9.8 | −12.2 | −13.3 | −12.6 | −10.8 |
| c* | | 10.6 | 10.4 | 12.8 | 13.8 | 13.3 | 13.0 |
| α̅(20° C.; 700° C.) | ppm/K | | | 0.92 | 1 | 0.95 | |
| Glass | | 19 | 20 | 20 | 21 | 21 | 22 |
| Example | | 127 | 128 | 129 | 130 | 131 | 132 |
| Comparative Example | | | | | | | |
| Properties of glass | | | | | | | |
| ceramic | | | | | | | |
| Variant | | C | C | C | C | C | C |
| Embodiment | 1 | 2 | 2 | 1 | 1 | 2 | |
| Ceramization | | g13 | g23 | g23 | g13 | g13 | g23 |
| methods 1 | | | | | | | |
| Ceramization | | g33 | g43 | | g33 | g33 | |
| methods 2 | | | | | | | |
| T_{D} | ° C. | 1065 | 1100 | 1080 | 1080 | 1065 | 1080 |
| t_{V} | min | 15 | 6.5 | 6.5 | 6.5 | 15 | 6.5 |
| Transmission(D65/2°), | mm | 3.99 | 4.00 | 3.93 | 3.93 | 3.87 | 3.89 |
| Thickness | | | | | | | |
| Y | % | 17.7 | 12.8 | 24.3 | 14.0 | 14.1 | 14.6 |
| Transmission at 630 | % | 28.9 | 20.0 | 37.9 | 22.0 | 22.2 | 20.5 |
| nm (PvK) | | | | | | | |
| Transmission at 630 | | | | | | | |
| nm (PiP) | | | | | | | |
| | % | 13.0 | 4.0 | 21.7 | 6.8 | 5.8 | 3.3 |
| (PvK-PiP)/PiP at 630 | | 1.2 | 4.0 | 0.7 | 2.2 | 2.8 | 5.3 |
| nm | | | | | | | |
| Transmission at 700 | % | 41.6 | 29.0 | 50.5 | 32.1 | 32.4 | 26.6 |
| nm (PvK) | | | | | | | |
| Transmission at 1600 | % | 86.2 | 84.6 | 85.6 | 86.1 | 86.1 | 79.9 |
| nm (PvK) | | | | | | | |
| Display capability for | | very | poor | very | good | good | poor |
| red | | good | | good | | | |
| Reflection (D65/2°), | mm | 3.99 | 4.00 | 3.93 | 3.93 | 3.87 | 3.89 |
| Thickness | | | | | | | |
| L* | | 74.1 | 80.1 | 68.8 | 78.5 | 79.6 | 75.1 |
| a* | | −7.3 | −4.8 | −5.5 | −5.9 | −5.9 | −3.5 |
| b* | | −9.9 | −10.8 | −18.5 | −9.1 | −8.3 | −7.5 |
| c* | | 12.3 | 11.8 | 19.3 | 10.9 | 10.1 | 8.3 |
| α̅(20° C.; 700° C.) | ppm/K | | 0.76 | | | | |
| Glass | | 22 | 22 | | | | |
| Example | | 133 | 134 | | | | |
| Comparative Example | | | | | | | |
| Properties of glass | | | | | | | |
| ceramic | | | | | | | |
| Variant | | C | C | | | | |
| Embodiment | | 2 | 2 | | | | |
| Ceramization | | g23 | g23 | | | | |
| methods 1 | | | | | | | |
| Ceramization | | | | | | | |
| methods 2 | | | | | | | |
| T_{D} | ° C. | 1065 | 1065 | | | | |
| t_{V} | min | 6.5 | 15 | | | | |
| Transmission(D65/2°), | mm | 3.90 | 3.90 | | | | |
| Thickness | | | | | | | |
| Y | % | 21.0 | 13.7 | | | | |
| Transmission at 630 | % | 29.5 | 19.0 | | | | |
| nm (PvK) | | | | | | | |
| Transmission at 630 | | | | | | | |
| nm (PiP) | | | | | | | |
| | % | 11.6 | 2.2 | | | | |
| (PvK-PiP)/PiP at 630 | | 1.5 | 7.6 | | | | |
| nm | | | | | | | |
| Transmission at 700 | % | 38.2 | 24.4 | | | | |
| nm (PvK) | | | | | | | |
| Transmission at 1600 | % | 82.5 | 79.1 | | | | |
| nm (PvK) | | | | | | | |
| Display capability for | | very good | poor | | | | |
| red | | | | | | | |
| Reflection (D65/2°), | mm | 3.90 | 3.90 | | | | |
| Thickness | | | | | | | |
| L* | | 67.7 | 75.5 | | | | |
| a* | | −3.8 | −3.2 | | | | |
| b* | | −10.1 | −5.9 | | | | |
| c* | | 10.8 | 6.7 | | | | |
| α̅(20° C.; 700° C.) | ppm/K | | | | | | |
| Glass | | 23 | 24 | 24 | 25 | | |
| Example | | 135 | 136 | 137 | 138 | | |
| Comparative | | | | | | | |
| Example | | | | | | | |
| Properties of glass | | | | | | | |
| ceramic | | | | | | | |
| Variant | | C | C | C | C | | |
| Embodiment | | 2 | 2 | 2 | 2 | | |
| Ceramization | | g23 | g23 | g23 | g23 | | |
| methods 1 | | | | | | | |
| Ceramization | | g43 | g43 | | | | |
| methods 2 | | | | | | | |
| T_{D} | ° C. | 1100 | 1080 | 1090 | 1100 | | |
| t_{V} | min | 6.5 | 6.5 | 6.5 | 6.5 | | |
| Transmission | mm | 3.96 | 3.94 | 4.00 | 3.94 | | |
| (D65/2°), Thickness | | | | | | | |
| Y | % | 15.5 | 16.5 | 13.8 | 15.9 | | |
| Transmission @ 630 | % | 21.9 | 22.9 | 19.3 | 24.8 | | |
| nm (PvK) | | | | | | | |
| Transmission @ 630 | % | 4.4 | 5.7 | 1.9 | 7.7 | | |
| nm (PiP) | | | | | | | |
| PvK-PiP @ 630 nm | % | 17.5 | 17.2 | 17.4 | 17.1 | | |
| (PvK-PiP)/PiP @ 630 | | 3.9 | 3.0 | 9.3 | 2.2 | | |
| nm | | | | | | | |
| Transmission @ 700 | % | 28.7 | 29.7 | 24.4 | 33.7 | | |
| nm (PvK) | | | | | | | |
| Transmission @ 1600 | % | 80.0 | 81.0 | 79.0 | 82.0 | | |
| nm(PvK) | | | | | | | |
| Display capability for | | good | very good | poor | very good | | |
| red | | | | | | | |
| Reflection (D65/2°), | mm | 3.96 | 3.94 | 4.00 | 3.94 | | |
| Thickness | | | | | | | |
| L* | | 73.1 | 69.9 | 76.4 | 70.8 | | |
| a* | | −3.4 | −2.8 | −2.7 | −3.7 | | |
| b* | | −7.7 | −7.6 | −5.6 | −10.6 | | |
| c* | | 8.4 | 8.1 | 6.2 | 11.2 | | |
| α̅(20° C.; 700° C.) | ppm/K | | | | | | |
| Glass | | 26 | 27 | 28 | 29 | 30 | 31 |
| Example | 139 | 140 | 141 | 142 | 143 | 144 | |
| Comparative | | | | | | | |
| Example | | | | | | | |
| Properties of glass | | | | | | | |
| ceramic | | | | | | | |
| Variant | | C | C | C | C | C | C |
| Embodiment | | 1 | 1 | 2 | 2 | 2 | 1 |
| Ceramization | | g13 | g13 | g23 | g23 | g23 | g13 |
| methods 1 | | | | | | | |
| Ceramization | | g33 | g33 | g33 | | | |
| methods 2 | | | | | | | |
| T_{D} | ° C. | 1080 | 1080 | 1080 | 1080 | 1080 | 1080 |
| t_{V} | min | 6.5 | 6.5 | 6.5 | 6.5 | 6.5 | 6.5 |
| Transmission | mm | 3.92 | 3.96 | 3.99 | 3.98 | 3.93 | 3.95 |
| (D65/2°), Thickness | | | | | | | |
| Y | % | 21.6 | 16.9 | 15.4 | 14.1 | 20.1 | 18.0 |
| Transmission @ 630 | % | 33.4 | 27.0 | 22.6 | 20.9 | 28.2 | 28.5 |
| nm (PvK) | | | | | | | |
| Transmission @ 630 | % | 17.7 | 11.6 | 5.3 | 4.1 | 10.2 | 12.4 |
| nm (PiP) | | | | | | | |
| PvK-PiP @ 630 nm | % | 15.7 | 15.5 | 17.4 | 16.7 | 18.1 | 16.2 |
| (PvK-PiP)/PiP @ 630 | | 0.9 | 1.3 | 3.3 | 4.1 | 1.8 | 1.3 |
| nm | | | | | | | |
| Transmission @ 700 | % | 45.7 | 38.7 | 29.9 | 28.1 | 36.5 | 40.2 |
| nm (PvK) | | | | | | | |
| Transmission @ 1600 | % | 85.9 | 85.8 | 82.8 | 82.5 | 82.9 | 85.1 |
| nm (PvK) | | | | | | | |
| Display capability for | | very | very | good | good | very | very |
| red | | good | good | | | good | good |
| Reflection(D65/2°), | mm | 3.92 | 3.96 | 3.99 | 3.98 | 3.93 | 3.95 |
| Thickness | | | | | | | |
| L* | | 71.4 | 74.1 | 73.1 | 75.1 | 68.5 | 73.5 |
| a* | | −5.4 | −6.3 | −4.6 | −4.6 | −3.5 | −6.2 |
| b* | | −14.0 | −9.1 | −6.8 | −6.0 | −9.0 | −11.6 |
| c* | | 15.0 | 11.0 | 8.2 | 7.5 | 9.7 | 13.2 |
| α̅(20° C.; 700° C.) | ppm/K | | 0.7 | | | | |
| Glass | | 32 | 33 | 34 | 35 | 36 | 37 |
| Example | | 145 | 146 | 147 | 148 | 149 | 150 |
| Comparative | | | | | | | |
| Example | | | | | | | |
| Properties of glass | | | | | | | |
| ceramic | | | | | | | |
| Variant | | C | C | C | C | C | C |
| Embodiment | | 1 | 2 | 2 | 2 | 2 | 2 |
| Ceramization | | g13 | g23 | g23 | g23 | g23 | g23 |
| methods 1 | | | | | | | |
| Ceramization | | g33 | g43 | g43 | g43 | g43 | g43 |
| methods 2 | | | | | | | |
| T_{D} | ° C. | 1080 | 1100 | 1100 | 1100 | 1100 | 1100 |
| t_{V} | min | 6.5 | 6.5 | 6.5 | 6.5 | 6.5 | 6.5 |
| Transmission | mm | 3.94 | 3.96 | 3.93 | 3.92 | 4.20 | 4.01 |
| (D65/2°), Thickness | | | | | | | |
| Y | % | 17.0 | 13.3 | 12.6 | 10.4 | 10.7 | 13.7 |
| Transmission @ 630 | % | 26.5 | 20.6 | 19.7 | 17.2 | 17.2 | 23.1 |
| nm (PvK) | | | | | | | |
| Transmission© 630 | % | 10.5 | 4.6 | 3.7 | 3.2 | 2.2 | 7.2 |
| nm (PiP) | | | | | | | |
| PvK-PiP @ 630 nm | % | 16.0 | 16.0 | 16.0 | 14.0 | 15.0 | 15.9 |
| (PvK-PiP)/PiP @ 630 | | 1.5 | 3.5 | 4.3 | 4.4 | 6.9 | 2.2 |
| nm | | | | | | | |
| Transmission @ 700 | % | 37.7 | 28.2 | 26.9 | 24.1 | 23.3 | 33.9 |
| nm (PvK) | | | | | | | |
| Transmission @ 1600 | % | 84.7 | 80.6 | 80.2 | 83.4 | 79.1 | 84.0 |
| nm (PvK) | | | | | | | |
| Display capability for | | very | good | good | good | poor | very |
| red | | good | | | | | good |
| Reflection (D65/2°), | mm | 3.94 | 3.96 | 3.93 | 3.92 | 4.20 | 4.01 |
| Thickness | | | | | | | |
| L* | | 74.8 | 72.3 | 73.4 | 72.2 | 74.0 | 72.4 |
| a* | | −6.2 | −3.0 | −3.8 | −2.7 | −3.4 | −4.0 |
| b* | | −9.6 | −9.9 | −8.0 | −8.6 | −8.0 | −11.8 |
| c* | | 11.4 | 10.3 | 8.8 | 9.0 | 8.7 | 12.5 |
| α̅(20° C.; 700° C.) | ppm/K | | 0.90 | 0.91 | 0.82 | 0.88 | 0.92 |
| Glass | | 38 | 39 | 40 | 41 | 42 | 43 |
| Example | | 151 | 152 | 153 | 154 | 155 | 156 |
| Comparative | | | | | | | |
| Example | | | | | | | |
| Properties of glass | | | | | | | |
| ceramic | | | | | | | |
| Variant | | C | C | C | C | C | C |
| Embodiment | | 2 | 2 | 2 | 2 | 2 | 2 |
| Ceramization | | g23 | g23 | g23 | g23 | g23 | g23 |
| methods 1 | | | | | | | |
| Ceramization | | g43 | g43 | g43 | g43 | g43 | g43 |
| methods 2 | | | | | | | |
| T_{D} | ° C. | 1100 | 1100 | 1100 | 1100 | 1100 | 1100 |
| t_{V} | min | 6.5 | 6.5 | 6.5 | 6.5 | 6.5 | 6.5 |
| Transmission | mm | 3.90 | 3.91 | 3.93 | 3.96 | 3.96 | 3.83 |
| (D65/2°), Thickness | | | | | | | |
| Y | % | 14.8 | 12.8 | 11.3 | 12.5 | 11.3 | 16.0 |
| Transmission @ 630 | % | 24.9 | 20.7 | 18.9 | 21.0 | 19.3 | 23.8 |
| nm (PvK) | | | | | | | |
| Transmission @ 630 | % | 9.3 | 4.4 | 3.4 | 4.7 | 3.6 | 6.1 |
| nm (PiP) | | | | | | | |
| PvK-PiP @ 630 nm | % | 15.6 | 16.3 | 15.5 | 16.3 | 15.7 | 17.7 |
| (PvK-PiP)/PiP @ 630 | | 1.7 | 3.7 | 4.6 | 3.5 | 4.4 | 2.9 |
| nm | | | | | | | |
| Transmission @ 700 | % | 35.9 | 29.3 | 27.4 | 30.4 | 27.9 | 31.8 |
| nm (PvK) | | | | | | | |
| Transmission @ 1600 | % | 83.7 | 83.3 | 83.0 | 83.1 | 83.3 | 81.6 |
| nm (PvK) | | | | | | | |
| Display capability for | | very | good | good | good | good | good |
| red | | good | | | | | |
| Reflection (D65/2°), | mm | 3.90 | 3.91 | 3.93 | 3.96 | 3.96 | 3.83 |
| Thickness | | | | | | | |
| L* | | 69.9 | 76.0 | 76.0 | 75.0 | 75.7 | 73.5 |
| a* | | −4.1 | −3.8 | −4.1 | −3.9 | −4.2 | −3.5 |
| b* | | −11.9 | −9.3 | −8.1 | −11.0 | −9.0 | −10.1 |
| c* | | 12.6 | 10.1 | 9.1 | 11.7 | 10.0 | 10.7 |
| α̅(20° C.; 700° C.) | ppm/K | 0.92 | 0.90 | 0.89 | 0.91 | 0.89 | 1.00 |
| Glass | | 44 | 45 | 46 | 47 | | |
| Example | | 157 | 158 | 159 | 160 | | |
| Comparative Example | | | | | | | |
| Properties of glass | | | | | | | |
| ceramic | | | | | | | |
| Variant | | C | C | C | C | | |
| Embodiment | | 2 | 2 | 2 | 2 | | |
| Ceramization | | g23 | g23 | g23 | g23 | | |
| methods 1 | | | | | | | |
| Ceramization | | g43 | g43 | g43 | g43 | | |
| methods 2 | | | | | | | |
| T_{D} | ° C. | 1100 | 1100 | 1100 | 1100 | | |
| t_{V} | min | 6.5 | 6.5 | 6.5 | 6.5 | | |
| Transmission(D65/2°), | mm | 3.94 | 3.94 | 3.92 | 4.06 | | |
| Thickness | | | | | | | |
| Y | % | 14.4 | 14.4 | 13.7 | 11.2 | | |
| Transmission @ 630 | % | 21.6 | 22.4 | 21.8 | 18.0 | | |
| nm (PvK) | | | | | | | |
| Transmission @ 630 | % | 4.5 | 5.5 | 5.2 | 3.2 | | |
| nm (PiP) | | | | | | | |
| PvK-PiP @ 630 nm | % | 17.1 | 16.9 | 16.6 | 14.8 | | |
| (PvK-PiP)/PiP @ 630 | | 3.8 | 3.1 | 3.2 | 4.6 | | |
| nm | | | | | | | |
| Transmission @ 700 | % | 29.1 | 30.4 | 29.9 | 24.8 | | |
| nm (PvK) | | | | | | | |
| Transmission @ 1600 | % | 81.4 | 82.2 | 81.5 | 80.3 | | |
| nm (PvK) | | | | | | | |
| Display capability for | | good | good | good | good | | |
| red | | | | | | | |
| Reflection (D65/2°), | mm | 3.94 | 3.94 | 3.92 | 4.06 | | |
| Thickness | | | | | | | |
| L* | | 74.5 | 73.4 | 73.5 | 72.5 | | |
| a* | | −4.0 | −3.5 | −4.0 | −2.9 | | |
| b* | | −8.4 | −10.8 | −9.9 | −9.6 | | |
| c* | | 9.3 | 11.3 | 10.7 | 10.0 | | |
| α̅(20° C.; 700° C.) | ppm/K | 1.00 | 1.01 | 0.99 | 0.91 | | |

TABLE 5
Long-duration annealing

| Glass | | 11 | 12 | 13 |
|---|---|---|---|---|
| Example | | 161 | 162 | 163 |
| Comparative | | | | |
| Example | | | | |
| Base example | | 78 | 21 | 83 |
| Properties of glass | | | | |
| ceramic | | | | |
| Variant | | B | A | B |
| Embodiment | 2 | 1 | 2 | |
| Ceramization | | g22 + | g11 + | g22 + |
| methods | | 700° C., | 700° C., | 700° C., |
| | | 10 h | 10 h | 10 h |
| T_{D} | ° C. | 1145 | 1145 | 1145 |
| tᵥ | min | 6.5 | 6.5 | 6.5 |
| Transmission | mm | 3.95 | 3.95 | 3.98 |
| (D65/2°), Thickness | | | | |
| Y | % | 4.4 | 0.6 | 3.0 |
| ΔY | % | −0.1 | 0.0 | -0.1 |
| Transmission at 630 | % | 8.0 | 1.6 | 6.3 |
| nm (PvK) | | | | |
| Transmission at 700 | % | 11.3 | 3.2 | 10.0 |
| nm (PvK) | | | | |
| Transmission at 1600 | % | 54.5 | 26.9 | 64.4 |
| nm (PvK) | | | | |
| Reflection (D65/2°), | mm | 3.95 | 3.95 | 3.98 |
| Thickness | | | | |
| L* | | 89.2 | 94.3 | 90.3 |
| ΔL* | | −0.5 | −0.3 | −0.2 |
| a* | | −0.9 | −0.3 | −1.0 |
| Δa* | | 0.1 | 0.0 | 0.0 |
| b* | | −2.8 | −0.9 | −2.5 |
| Δb* | | 0.1 | 0.0 | −0.1 |
| c* | | 2.9 | 1.0 | 2.7 |
| Glass | | 14 | 15 | 19 |
| Example | | 165 | 166 | |
| Comparative | 164 | | | |
| Example | | | | |
| Base Example | 26 | 87 | 37 | |
| Properties of glass | | | | |
| ceramic | | | | |
| Variant | | A | B | A |
| Embodiment | | | 2 | 1 |
| Ceramization | | g21 + | g22 + | g11 + |
| methods | | 700° C., | 700° C., | 700° C., |
| | | 10 h | 10 h | 10 h |
| T_{D} | ° C. | 1145 | 1145 | 1145 |
| tᵥ | min | 6.5 | 6.5 | 6.5 |
| Transmission | mm | 3.95 | 3.97 | 4.00 |
| (D65/2°), Thickness | | | | |
| Y | % | 1.5 | 3.7 | 1.6 |
| ΔY | % | 0.0 | −0.1 | −0.1 |
| Transmission at 630 | % | 4.0 | 7.2 | 4.0 |
| nm (PvK) | | | | |
| Transmission at 700 | % | 6.2 | 10.7 | 7.3 |
| nm (PvK) | | | | |
| Transmission at 1600 | % | 29.0 | 58.4 | 68.8 |
| nm (PvK) | | | | |
| Reflection (D65/2°), | mm | 3.95 | 3.97 | 4.00 |
| Thickness | | | | |
| L* | | 95.2 | 90.3 | 93.0 |
| ΔL* | | 0.2 | −0.1 | −0.3 |
| a* | | −0.7 | −0.8 | −1.1 |
| Δa* | | 0.0 | 0.1 | 0.0 |
| b* | | −2.0 | −2.6 | −1.2 |
| Δb* | | −0.1 | 0.2 | −0.2 |
| c* | | 2.1 | 2.8 | 1.7 |
| Glass | | 20 | 21 | 22 |
| Example | | 167 | 168 | 169 |
| Comparative | | | | |
| Example | | | | |
| Base Example | | 94 | 42 | 98 |
| Properties of glass | | | | |
| ceramic | | | | |
| Variant | | B | A | B |
| Embodiment | | 2 | 1 | 2 |
| Ceramization | | g22 + | g11 + | g22 + |
| methods | | 700° C., | 700° C., | 700° C., |
| | | 10 h | 10 h | 10 h |
| T_{D} | ° C. | 1145 | 1145 | 1145 |
| tᵥ | min | 6.5 | 6.5 | 6.5 |
| Transmission | | | | |
| (D65/2°), Thickness | | | | |
| mm | | 4.01 | 3.99 | 3.99 |
| Y | % | 3.5 | 1.5 | 2.2 |
| ΔY | % | −0.1 | 0.1 | −0.1 |
| Transmission at 630 | % | 7.2 | 3.6 | 5.0 |
| nm (PvK) | | | | |
| Transmission at 700 | % | 11.0 | 6.5 | 8.3 |
| nm (PvK) | | | | |
| Transmission at 1600 | % | 75.4 | 66.1 | 50.1 |
| nm (PvK) | | | | |
| Reflection (D65/2°), | mm | 4.01 | 3.99 | 3.99 |
| Thickness | | | | |
| L* | | 92.0 | 94.2 | 90.1 |
| ΔL* | | −0.3 | 0.0 | −0.5 |
| a* | | −1.4 | −0.6 | −0.5 |
| Δa* | | 0.0 | 0.1 | 0.0 |
| b* | | −3.4 | −1.7 | −2.6 |
| Δb* | | −0.4 | −0.2 | −0.3 |
| c* | | 3.6 | 1.8 | 2.6 |

What is claimed is:

1. A lithium aluminum silicate glass ceramic, which, is free from As2O3 and Sb2O3, with keatite as a primary crystal phase, comprising:
a keatite peak temperature (TP) of a keatite solid solution formation in the range of 980° C. to 1090° C.;
wherein the keatite TP is determined by dynamic differential calorimetry (DSC) in accordance with DIN 51007:2019-04 at a heating rate of 5 K·min⁻¹.

2. The glass ceramic according to claim 1, comprising the following components in the following proportions (in wt % based on oxide):

| | |
|---|---|
| Li2O | 3-5 |
| Al2O3 | 18-25 |
| SiO2 | 60-70 |
| SnO2 | 0-0.5. |

3. The glass ceramic according to claim 1, wherein the glass ceramic has a perceptual lightness L* in the color space L*, a*, b* of 60 to 97 and a brightness Y of 0.1% to 25%; wherein L* and Y are determined using the standard illuminant D65 at an angle of 2° for a 4 mm thickness of the glass ceramic.

4. The glass ceramic according to claim 1, wherein the glass ceramic is opaque and has a keatite TP in the range of 980° C. to 1070° C. as well as the following values:
L*=85 to 97
a*=−1.5 to 0.5
b*=−6 to 0.5
and Y=0.1% to 2%.

5. The glass ceramic according to claim 1, wherein the glass ceramic is translucent and has a keatite TP in the range of 980° C. to 1070° C. as well as the following values:
L*=72 to 93
a*=−5.5 to 0
b*=−7 to 0.5
and Y=>2% to 10%.

6. The glass ceramic according to claim 1, wherein the glass ceramic is translucent and has a keatite peak temperature TP in the range of 980° C. to 1070° C. as well as the following values:
L*=60 to 82
a*=−7.5 to −2
b*=−19 to −4.5
and Y=>10% to 25%.

7. The glass ceramic according to claim 1, wherein the glass ceramic has a coefficient of mean linear thermal expansion α̅(20° C.; 700° C.) of 0 to 2.0×10⁻⁶/K.

8. The glass ceramic according to claim 1, further comprising 0.01 to <1 wt % MgO.

9. The glass ceramic according to claim 1, further comprising 0.5 to 3 wt % ZnO.

10. The glass ceramic according to claim 1, wherein the glass ceramic contains no more than 0.065 wt % Nd2O3.

11. The glass ceramic according to claim 1, wherein the glass ceramic contains 0 to 2 wt % P2O5.

12. The glass ceramic according to claim 1, wherein the glass ceramic contains the following components (in wt % based on oxide):

| | |
|---|---|
| Li2O | 3.2-<4.5 |
| Al2O3 | 19-23 |
| SiO2 | 62-68 |
| Na2O | 0.05-1 |
| K2O | 0-1 |
| Na2O + K2O | 0.15-1.2 |
| MgO | 0.1-0.8 |
| CaO | 0.05-1 |
| SrO | 0-1.5 |
| BaO | 0-2.5 |
| SrO + BaO | 0.5-2.5 |
| ZnO | 1-2.9 |
| B2O3 | 0-1 |
| TiO2 | 1.8-2.8 |
| ZrO2 | 1-<2.2 |
| SnO2 | 0.01-<0.25 |
| TiO2 + ZrO2 + SnO2 | 3.6-4.8 |
| P2O5 | 0-2 |
| Fe2O3 | 0.008-0.05 |

with 0.005 < MgO × SnO2 < 0.1 (condition B3a)

13. The glass ceramic according to claim 5, wherein the glass ceramic has a quotient (PvK−PiP)/PiP of 20 for light of wavelength 630 nm.

14. A method for producing a glass ceramic according to claim 1, comprising a crystallizable As2O3-free and Sb2O3-free lithium aluminum silicate glass, and wherein the ceramization is carried out with the following method steps in the following sequence:
a) increasing the temperature of the crystallizable glass from room temperature TRT to a temperature Ta in the range of 660 to 730° C. within 3 to 60 minutes;
b) increasing the temperature of the crystallizable glass from Ta to a temperature up to at most 800° C. over a time period of 5 to 100 minutes;
c) increasing the temperature of the glass containing crystallization seeds within 5 to 80 minutes duration in the temperature range Tb of beginning HQ solid solution formation of 780 to 850° C.;
d) residence in the temperature range Tb over a time period of 5 to 120 minutes;
e) increasing the temperature of the glass containing HQ-solid solution within 5 to 80 minutes duration in the temperature range TC of high crystal growth rate from 900° C. to 950° C.;
f) increasing the temperature of the glass containing HQ-solid solution within 5 to 80 minutes duration in the temperature range TD from 950° C. to 1250° C.;
g) residence in the temperature range TD over a residence time tV>0 to 60 minutes; and
h) rapid cooling of the obtained glass ceramic to room temperature in less than 150 minutes;
wherein the ceramization of the glass comprises a total time of less than 300 min.

15. The method according to claim 14, for producing a glass ceramic that has a keatite TP≤1005° C., wherein in the method step g), the following method step is carried out:
g11) residence at a temperature TD in the range of 1120° C. to 1180° C., over a residence time tV of 5 minutes to 20 minutes.

16. The method according to claim 14, for producing a glass ceramic that has a keatite TP≤1005° C., wherein in the method step g), the following method step is carried out:
g12) residence at a temperature TD in the range of 1060° C. to 1120° C., over a residence time tV of 5 minutes to 20 minutes.

17. The method according to claim 14, for producing a glass ceramic that has a keatite TP≤1005° C., wherein in the method step g), the following method step is carried out:
g13) residence at a temperature TD in the range of 1035° C. to 1080° C., over a residence time tV of 5 minutes to 20 minutes.

18. The method according to claim 14, for producing a glass ceramic that has a keatite TP>1005° C., wherein in the method step g), the following method step is carried out:
g21) residence at a temperature TD in the range of 1145° C. to 1180° C., over a residence time tV of 5 minutes to 20 minutes.

19. The method according to claim 14, for producing a glass ceramic that has a keatite peak temperature TP>1005° C., wherein in the method step g), the following method step is carried out:
g22) residence at a temperature TD in the range of 1100° C. to 1150° C., over a residence time tV of 5 minutes to 20 minutes.

20. The method according to claim 14, for producing a glass ceramic that has a keatite TP>1005° C., wherein in the method step g), the following method step is carried out:
g23) residence at a temperature TD in the range of 1050° C. to 1100° C., over a residence time tV of 5 minutes to 20 minutes.
